SEQUENCE LISTING (26 sequences)

SEQ ID NO: 1 - protein, 300 aa, Bacillus subtilis
AATTGTGTTLKGKTVSLNISSESGKYVLRDLSKPTGTQIITYDLQNREYNLPGTLVSSTTNQFTTSSQRAAVDAHYNLGKVYDYFYQKFNRNSYDNKGGKIVSSVHYGSRYNNAAWIGDQMIYGDGDGSFFSPLSGSMDVTAHEMTHGVTQETANLNYENQPGALNESFSDVFGYFNDTEDWDIGEDITVSQPALRSLSNPTKYGQPDNFKNYKNLPNTDAGDYGGVHTNSGIPNKAAYNTITKIGVNKAEQIYYRALTVYLTPSSTFKDAKAALIQSARDLYGSQDAASVEAAWNAVGL

SEQ ID NO: 2 - protein, 274 aa, Bacillus licheniformis
AQTVPYGIPLIKADKVQAQGFKGANVKVAVLDTGIQASHPDLNVVGGASFVAGEAYNTDGNGHGTHVAGTVAALDNTTGVLGVAPSVSLYAVKVLNSSGSGSYSGIVSGIEWATTNGMDVINMSLGGASGSTAMKQAVDNAYARGVVVVAAAGNSGSSGNTNTIGYPAKYDSVIAVGAVDSNSNRASFSSVGAELEVMAPGAGVYSTYPTNTYATLNGTSMASPHVAGAAALILSKHPNLSASQVRNRLSSTATYLGSSFYYGKGLINVEAAAQ

SEQ ID NO: 3 - protein, 269 aa, Bacillus clausii
AQSVPWGISRVQAPAAHNRGLTGSGVKVAVLDTGISTHPDLNIRGGASFVPGEPSTQDGNGHGTHVAGTIAALNNSIGVLGVAPSAELYAVKVLGASGSGSVSSIAQGLEWAGNNGMHVANLSLGSPSPSATLEQAVNSATSRGVLVVAASGNSGAGSISYPARYANAMAVGATDQNNNRASFSQYGAGLDIVAPGVNVQSTYPGSTYASLNGTSMATPHVAGAAALVKQKNPSWSNVQIRNHLKNTATSLGSTNLYGSGLVNAEAATR

SEQ ID NO: 4 - protein, 275 aa, Bacillus amyloliquefaciens [sequence omitted]

SEQ ID NO: 5 - protein, 274 aa, Bacillus licheniformis
AQTVPYGIPLIKADKVQAQGFKGANVKVAVLDTGIQASHPDLNVVGGASFVAGEAYNTDGNGHGTHVSGTVAALDNNIGVLGVAPSVSLYAVKVLNSSGSGSYSGIVSGIEWATTNGMDVINMSLGSPSGSTAMKQAVDNAYARGVVVVAAAGNSGSSGNTNTIQYPAKYDSVIAVGAVDSNSQRASFSSVGAELEVMAPGVGVYSTYPTNTYATLSGTSMASPHVAGAAALILSKHPNLSASQVRNRLSSTATYLGPSFYYGKGLINVEAAAQ

SEQ ID NO: 6 - protein, 276 aa, Bacillus sp. [sequence omitted]

SEQ ID NO: 7 - protein, 269 aa, Bacillus gibsonii
QQTVPWGITRVQAPTVHNRGITGSGVKVAILDTGIAQHSDLTIRGGASFVPGESTTADLNGHGTHVAGTVAALNNSIGVIGVAPSADLYAVKVLGANGRGSVSGIAQGLEWAATNNMHIANMSLGSDAPSTTLERAVNYATSRGVLVIAATGNNGTGSIGYPARYANAMAVGATDQNNRRASFSQYGTGIDIVAPGVGIQSTYLNNSYASLDGTSMATPHVAGVAALVKQKNPSWNATQIRNHLKNTATNLGNSSQFGSGLVNADAATR

SEQ ID NO: 8 - protein, 269 aa, Bacillus gibsonii; identical to SEQ ID NO: 7

SEQ ID NO: 9 - protein, 269 aa, Bacillus lentus
AQSVPWGIERVQAPAAHNRGLTGSGVKVAVLDTGISTHPDLRIRGGASFVPGEPSTQDGNGHGTHVAGTIAALDNSIGVLGVAPSAELYAVKVLGASGSGSVSSIAQGLEWAGNNGMHVANLSLGSPSPSATLEQAVNSATSRGVLVVAASGNSGAGSISYPARYANAMAVGATDQNNNRASFSQYGAGLDIVAPGVNILSTWPGSTYASLNGTSMATPHVAGAAALVKQKNPSWSNVQIRNHLKNTATSLGDTWEYGSGLVNAEAATR

SEQ ID NO: 10 - protein, 269 aa, Bacillus lentus
AQSVPWGIERVQAPAAHNRGLTGSGVKVAVLDTGISTHPDLRIRGGASFVPGEPSTQDGNGHGTHVAGTIAALDNSIGVLGVAPSAELYAVKVLDASGSGSVSSIAQGLEWAGNNGMHVANLSLGSPSPSATLEQAVNSATSRGVLVVAASGNSGAGSISYPARYANAMAVGATDQNNNRASFSQYGAGLDIVAPGVNILSTWPGSTYKSLNGTSMATPHVAGAAALVKQKNPSWSNVQIRNHLKNTATSLGDTWEYGSGLVNAEAATR

SEQ ID NO: 11 - protein, 269 aa, Bacillus lentus
AQSVPWGISRVQAPAAHNRGLTGSGVKVAVLDTGISTHPDLNIRGGASFVPGEPSTQDGNGHGTHVAGTIAALNNSIGVLGVAPSAELYAVKVLGASGSGSVSSIAQGLEWAGNNGMHVANLSLGSPSPSATLEQAVNSATSRGVLVVAASGNSGAGSISAPASYANAMAVGATDQNNNRASFSQYGPGLDIVAPGVNVQSTYPGSTYASLNGTSMATPHVAGAAALVKQKNPSWSNVQIRNHLKNTATSLGSTNLYGSGLVNAEAATR

SEQ ID NO: 12 - protein, 270 aa, Bacillus lentus
AQSVPWGISRVQAPAAHNRGLTGSGVKVAVLDTGISTHPDLNIRGGASFVPGEPSTQDGNGHGTHVAGTIAALNNSIGVLGVAPSAELYAVKVLGAADGSGSVSSIAQGLEWAGNNGMHVANLSLGSPSPSATLEQAVNSATSRGVLVVAASGNSGAGSISYPARYANAMAVGATDQNNNRASFSQYGAGLDIVAPGVNVQSTYPGSTYASLNGTSMATPHVAGAAALVKQKNPSWSNVQIRNHLKNTATSLGSTNLYGSGLVNAEAATR

SEQ ID NO: 13 - protein, 269 aa, Bacillus lentus
AQSVPWGIRRVQAPTAHNRGLTGSGVKVAVLDTGISTHPDLNIRGGASFVPGEPSTQDGNGHGTHAAGTIAALNNSIGVLGVAPSAELYAVKVLGASGSGSVSSIAQGLEWAGNNGMHVANLSLGSPSPSATLEQAVNSATSRGVLVVAASGNSGAGSISYPARYANAMAVGATDQNNNRASFSQYGAGLDIVAPGVNVQSTYPGSTYASLDGTSMATPHVAGAAALVKQKNPSWSNVRIRNHLKNTATSLGSTNLYGSGLVNAEAATR

SEQ ID NO: 14 - protein, 269 aa, Bacillus lentus
AQSVPWGIRRVQAPTAHNRGLTGSGVKVAVLDTGISTHPDLNIRGGASFVPGEPSTQDENGHGTHAAGTIAALNNSIGVLGVAPSAELYAVKVLGASGSGSVSSIAQGLEWAGNNGMHVANLSLGSPSPSATLEQAVNSATSRGVLVVAASGNSGAGSISYPARYANAMAVGATDQNNNRASFSQYGPGLDIVAPGVNIQSTYPGSTYASLNGTSMATPHVAGAAALVKQKNPSWSNVRIRNHLKNTATSLGSTDLYGSGLVNAEAATR

SEQ ID NO: 15 - protein, 269 aa, Bacillus lentus
AQTVPWGIRRVQAPAAHNLGLTGSGVKVAVLDTGISTHPDLNIRGGASFVPGEPSTQDGDGHGTHVAGTIAALNNSIGVLGVAPSAELYAVKVLGASGSGSVSSIAQGLEWAGNNGMHVANLSLGSPSPSATLEQAVNSATSRGVLVVAASGNSGAGSISYPARYANAMAVGATDQNNNRASFSQYGPGLDIVAPGVNVQSTYPGSTYASLNGTSMATPHVAGAAALVKQKNPSWSNVQIRNHLKNTATSLGSTNLYGSGLVNAEAATR

SEQ ID NO: 16 - protein, 269 aa, Bacillus lentus
AQSVPWGISRVQAPAAHNRGLTGSGVKVAVLDTGISTHPDLNIRGGASFVPGEPSTQDGNGHGTHVAGTIAALNNSIGVLGVAPSAELYAVKVLGADGRGAISSIAQGLEWAGNNGMHVANLSLGSPSPSATLEQAVNSATSRGVLVVAASGNSGASSISYPARYANAMAVGATDQNNNRASFSQYGAGLDIVAPGVNVQSTYPGSTYASLNGTSMATPHVAGAAALVKQKNPSWSNVQIRNHLKNTATSLGSTNLYGSGLVNAEAATR

SEQ ID NO: 17 - protein, 269 aa, Bacillus lentus
AQTIPWGISRVQAPAAHNRGLTGSGVKVAVLDTGISTHPDLNIRGGASFVPGEPSTQDGNGHGTHVAGTIAALNNSIGVLGVAPSAELYAVKVLGADGRGAISSIAQGLEWAGNNGMHVANLSLGSPSPSATLEQAVNSATSRGVLVVAASGNSGASSISYPARYANAMAVGATDQNNNRASFSQYGAGLDIMAPGVNIQSTYPGSTYASDNGTSMATPHVAGAAALVKQKNPSWSNVQIRNHLKNTATSLGSTNLYGSGLVNAEAATR

SEQ ID NO: 18 - protein, 269 aa, Bacillus lentus
AQSVPWGISRVQAPAAHNRGLTGSGVKVAVLDTGISTHPDLNIRGGASFVPGEPSTQDGNGHGTHVAGTIAALNNSIGVLGVAPSAELYAVKVLGADGEGAISSIAQGLEWAGNNGMHVANLSLGSPSPSATLEQAVNSATSRGVLVVAASGNSGASSISYPARYANAMAVGATDQNNNRASFSQYGAGLDIVAPGVNVQSTYPGSTYASLNGTSMATPHVAGAAALVKQKNPSWSNVQIRNHLKNTATSLGSTNLYGSGLVNAEAATR

SEQ ID NO: 19 - protein, 269 aa, Bacillus lentus
AQTIPWGISRVQAPAAHNRGLTGSGVKVAVLDTGISTHPDLNIRGGASFVPGEPSTQDGNGHGTHVAGTIAALNNSIGVLGVAPSAELYAVKVLGADGEGAISSIAQGLEWAGNNGMHVANLSLGSPSPSATLEQAVNSATSRGVLVVAASGNSGASSISYPARYANAMAVGATDQNNNRASFSQYGAGLDIVAPGVNIQSTYPGSTYASLNGTSMATPHVAGAAALVKQKNPSWSNVQIRNHLKNTATSLGSTNLYGSGLVNAEAATR

SEQ ID NO: 20 - protein, 275 aa, Bacillus sp.
AQTVPWGIPHIKADKAHAAGVTGSGVKVAILDTGIDANHADLNVKGGASFVSGEPNALQDGNGHGTHVAGTVAALNNTTGVLGVAYNADLYAVKVLSASGSGTLSGIAQGIEWSISNGMNVINMSLGGSSGSTALQQACNNAYNRGIVVIAAAGNSGSSGNRNTMGYPARYSSVIAVGAVSSNNTRASFSSVGSELEVMAPGVNILSTTPGNNYASFNGTSMAAPHVAGAAALIKAKYPSMTNVQIRERLKNTATNLGDPFFYGKGVINVESALQ

SEQ ID NO: 21 - protein, 221 aa, Bacillus lechiniformis
VIGSDDRTRVTNTTAYPYRAIVHISSSIGSCTGWMIGPKTVATAGHCIYDTSSGSFAGTATVSPGRNGTSYPYGSVKSTRYFIPSGWRSGNTNYDYGAIELSEPIGNTVGYFGYSYTTSSLVGTTVTISGYPGDKTAGTQWQHSGPIAISETYKLQYAMDTYGGQSGSPVFEQSSSRTNCSGPCSLAVHTNGVYGGSSYNRGTRITKEVFDNLTNWKNSAQ

SEQ ID NO: 22 - protein, 224 aa, Fusarium oxysporum
IVGGTSASAGDFPFIVSISRNGGPWCGGSLLNANTVLTAAHCVSGYAQSGFQIRAGSLSRTSGGITSSLSSVRVHPSYSGNNNDLAILKLSTSIPSGGNIGYARLAASGSDPVAGSSATVAGWGATSEGGSSTPVNLLKVTVPIVSRATCRAQYGTSAITNQMFCAGVSSGGKDSCQGDSGGPIVDSSNTLIGAVSWGNGCARPNYSGVYASVGALRSFIDTYA

SEQ ID NO: 23 - protein, 555 aa, unidentified
MRGYEFLSVLPLVAASWALPGSTPASVGRRQLPKNPTGVKTLTTANNVTIRYKEPGAEGVCETTPGVKSYSGYVDTSPESHTFFWFFEARHNPETAPITLWLNGGPGSDSLIGLFEELGPCHVNSTFDDYINPHSWNEVSNLLFLSQPLGVGFSYSDTVDGSINPVTGVVENSSFAGVQGRYPTIDATLIDTTNLAAEAAWEILQGFLSGLPSLDSRVQSKDFSLWTESYGGHYGPAFFNHFYEQNERIANGSVNGVQLNFNSLGIINGIIDEAIQAPYYPEFAVNNTYGIKAVNETVYNYMKFANQMPNGCQDLISTCKQTNRTALADYALCAEATNMCRDNVEGPYYAFAGRGVYDIRHPYDDPTPPSYYNKFLAKDSVMDAIGVNINYTQSNNDVYYAFQQTGDFVWPNFIEDLEEILALPVRVSLIYGDADYICNWFGGQAVSLAANYSQAAQFRSAGYTPLKVNGVEYGETREYGNFSFTRVYEAGHEVPYYQPIASLQLFNRTIFGWDIAEGQKKIWPSYKTNGTATATHTQSSVPLPTATSMSSVGMA

SEQ ID NO: 24 - protein, 496 aa, Aspergillus oryzae
MRSLLWASLLSGVLAGRALVSPDEFPEDIQLEDLLEGSQQLEDFAYAYPERNRVFGGKAHDDTVNYLYEELKKTGYYDVYKQPQVHLWSNADQTLKVGDEEIEAKTMTYSPSVEVTADVAVVKNLGCSEADYPSDVEGKVALIKRGECPFGDKSVLAAKAKAAASIVYNNVAGSMAGTLGAAQSDKGPYSAIVGISLEDGQKLIKLAEAGSVSVDLWVDSKQENRTTYNVVAQTKGGDPNNVVALGGHTDSVEAGPGINDDGSGIISNLVIAKALTQYSVKNAVRFLFWTAEEFGLLGSNYYVSHLNATELNKIRLYLNFDMIASPNYALMIYDGDGSAFNQSGPAGSAQIEKLFEDYYDSIDLPHIPTQFDGRSDYEAFILNGIPSGGLFTGAEGIMSEENASRWGGQAGVAYDANYHAAGDNMTNLNHEAFLINSKATAFAVATYANDLSSIPKRNTTSSLHRRARTMRPFGKRAPKTHAHVSGSGCWHSQVEA

SEQ ID NO: 25 - protein, 269 aa, Bacillus lechiniformis
AQTVPWGISRVQAPAAHNRGLTGSGVKVAVLDTGISTHPDLRIRGGASFVPGEPSTQDGNGHGTHVAGTIAALDNSIGVLGVAPNAELYAVKVLGASGSGSVSSIAQGLEWAGNNMMHVANLSLGQPSPSATLEQAVNSATSRGVLVVAASGNSGAGSISYPARYANAMAVGATDQNNERASFSQYGAGLDIVAPGVNILSTWPGSTYASLNGTSMATPHVAGAAALVKQKNPSWSNVQIRNHLKNTATSLGDTWEYGSGLVNAEAATR

SEQ ID NO: 26 - protein, 358 aa, Bacillus sp.
VAQDQKPQEIIVKFKPGTSSTKAASIHATAKGQVASKHAKLGYQVIKLNKGQSVQEAINAYKKNPNVEYVEPNGEVHATFIPNDPKYSQQYAPQKVGAEAAWDVTKGSNQVKVAIVDTGVDYNHPDLAGKVEKGKDFIDNDNDPMDENSHGTHCAGIAAAKTNNGEGIAGMAPEVTILAERVLDANGSGTWDSVANGITHAADAGAQVISLSLGGPQSSQTLENAVKYAASKGAVIVAAAGNESTSAPSYPGRYDEAIAVAATDQNDKKASFSNYGDWVDVAAPGVNILSTVPGGGYAAMSGTSMATPLVAGEAALLASQGKSASEIRQAIEGTADKISGTGTYWAHGRINAANAVKQ

(19) United States
(12) Patent Application Publication
(10) Pub. No.: US 2026/0250605 A1
(43) Pub. Date: Aug. 27, 2026

(54) DETERGENT COMPOSITIONS BASED ON BIOSURFACTANTS

(71) Applicant: Novozymes A/S, Bagsvaerd (DK)

(72) Inventor: Jürgen Carsten Franz Knötzel, Copenhagen (DK)

(73) Assignee: Novozymes A/S, Bagsvaerd (DK)

(21) Appl. No.: 19/163,308

(22) PCT Filed: Mar. 18, 2024
(86) PCT No.: PCT/EP2024/057127

§ 371 Date: Sep. 8, 2025

(30) Foreign Application Priority Data
Mar. 21, 2023 (EP) 23163190.4

(51) Int. Cl. C11D 3/386; C11D 1/06; C11D 1/14

(52) U.S. Cl. CPC C11D 3/38636; C11D 1/06; C11D 1/146; C11D 2111/12; C11D 2111/14

(57) ABSTRACT

The present invention relates to consumer product composition, such as detergent composition, wherein the composition is based on or more biosurfactant(s) and optionally one or more enzymes, such as a protease.

### REFERENCE TO SEQUENCE LISTING

This application contains a Sequence Listing in computer readable form. The computer readable form is incorporated herein by reference.

### FIELD OF THE INVENTION

The present invention relates to a consumer product composition, such as a detergent composition, wherein the composition is based on one or more biosurfactant(s) and optionally one or more enzymes, such as a protease.

### BACKGROUND OF THE INVENTION

Increasingly, consumers demand products that carries less burden to the environment, i.e. products that stem from renewable resources. Many ingredients in consumer products, such a detergents for laundry, dish wash or hard surface cleaning, are often derived from petrochemical resources and have faced scrutiny due to environmental concerns, most of all for not being sustainable because they are from a non-renewable source and are poorly biodegradable or even persistent in the environment. It is desirable to provide alternatives that have an improved sustainability profile while maintaining compatibility with other detergent ingredients. In addition, the consumer benefits and performance effects must be maintained.

EP3271448B1 discloses the use of combination linear alkylbenzene sulfonate and rhamnolipid for improvement of the performance of proteases in laundry.

WO 2021/058023 and WO 2021/058022 disclose the use of cellulase, xyloglucanase and deoxyribonuclease—alone or in combination—for replacement of anti-redeposition polymers in order to reduce the environmental footprint.

### SUMMARY OF THE INVENTION

Petrochemically derived ingredients present in detergents are not sustainable because they are derived from a non-renewable source and are poorly biodegradable or even persistent in the environment. The inventors of the present invention have surprisingly found that more sustainable detergent compositions, i.e. detergent compositions with an improved sustainability profile, can be achieved by replacing petrochemically derived compounds, such as linear alkylbenzene sulfonate, with biosurfactants, such as rhamnolipid, while maintaining or even improving the wash performance of the detergent. In addition to being produced from a renewable agricultural source, the biosurfactants are readily biodegradable.

The invention addresses the United Nations' Sustainable Development Goals, in particular Goal 12 “Responsible consumption and production”: replacing petrochemically derived compounds, such as linear alkylbenzene sulfonate (LAS), in detergents by addition of biosurfactant, such as rhamnolipid, allows the detergent producer—and thus the end user—to move from a non-renewable feedstock to a renewable feedstock and reduce the volume of persistent chemicals emitted to the environment. Consequently, the invention discloses how biosurfactant can replace petrochemically derived compounds, such as LAS, by addition of biosurfactant, such as rhamnolipid in consumer products, such as detergents, thereby improving the sustainability profile of the detergent.

A further reduction in the use petrochemically derived compounds can be obtained by replacing anti-redeposition polymers partly or fully with cellulases, xyloglucanases and/or deoxyribonucleases.

### Definitions

In accordance with this detailed description, the following definitions apply. Note that the singular forms “a,” “an,” and “the” include plural references unless the context clearly dictates otherwise. Unless defined otherwise or clearly indicated by context, all technical and scientific terms used herein have the same meaning as commonly understood by one of ordinary skill in the art to which this invention belongs.

### Active Ingredient

Unless otherwise specified the amount of an ingredient, e.g. a surfactant, is the active amount, i.e. where solvents (e.g. water) and impurities are excluded from the indicated amount.

### Alkylbenzene Sulphonate

Alkylbenzene sulfonates are a class of anionic surfactants, consisting of a hydrophilic sulfonate head-group and a hydrophobic alkylbenzene tail-group:

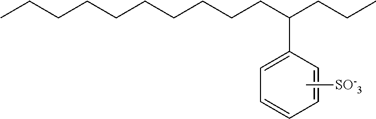

In linear alkylbenzene sulphonate (LAS) as depicted above the tail-group is unbranched (as opposed to branched alkylbenzene sulphonate (BAS)). The traditional LAS product contains a spread of chain lengths, typically with a mean around C12, and of points of attachment of the alkyl chain to the benzene ring as well. The counter ion in LAS products is often Nat, but others may be preferable from a solubility point of view.

### Alkyl Ethoxysulfate

Alkyl ethoxysulfates (AES) have the general structure

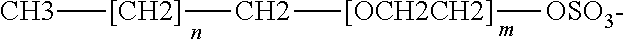

and comprise a combination of nonionic head group with an anionic one. The alkyl chain length range (n) varies, but typical range for n is 9 to 14 and the number of oxyethylene groups (m) is in the range 2 to 5. An alkyl ethoxysulfate often used in detergents is lauryl ether sulfate, e.g. sodium lauryl ether sulfate (SLES). Investigation of the environmental impact of AES shows that the use of AES in household detergents and cleaning products results in risk characterization ratios less than one, indicating no environmental concern. Consequently, the use of AES as an (additional) anionic surfactant in the detergent composition complies with the aspect of providing a sustainable detergent.

### Antiredeposition Polymer

In the context of the present invention polymers include but are not limited to polyacrylic acid, a modified polyacrylic acid polymer, a modified polyacrylic acid copolymer, a maleic acid-acrylic acid copolymer, carboxymethyl cellulose, cellulose gum, methyl cellulose, and/or combinations thereof.

### Bacterial

The term “bacterial” in relation to polypeptide (such as an enzyme, e.g. a protease) refers to a polypeptide encoded by and thus directly derivable from the genome of a bacteria, where such bacteria has not been genetically modified to encode said polypeptide, e.g. by introducing the encoding sequence in the genome by recombinant DNA technology. In the context of the present invention, the term “bacterial enzyme” or “polypeptide having enzyme activity obtained from a bacterial source” or “polypeptide is of bacterial origin” thus refers to a enzyme encoded by and thus directly derivable from the genome of a bacterial species, where the bacterial species has not been subjected to a genetic modification introducing recombinant DNA encoding said enzyme. Thus, the nucleotide sequence encoding the bacterial polypeptide having enzyme activity is a sequence naturally in the genetic background of a bacterial species. A sequence encoding a bacterial polypeptide having enzyme activity may also be referred to a wildtype enzyme (or parent enzyme). Bacterial polypeptide having enzyme activity includes recombinant produced wild types. In a further aspect, the invention provides polypeptides having enzyme activity, wherein said polypeptides are substantially homologous to a bacterial enzyme. In the context of the present invention, the term “substantially homologous” denotes a polypeptide having enzyme activity which is at least 80%, preferably at least 85%, more preferably at least 90%, more preferably at least 95%, even more preferably at least 96%, 97%, 98%, and most preferably at least 99% identical to the amino acid sequence of a selected bacterial enzyme.

### Biosurfactant

Biosurfactants are in the context of the present invention surfactants that can be obtained by fermentation process, and are produced from renewable raw materials and include, but are not limited to, rhamnolipid, sophorolipid and mannosylerythritol lipids.

### Color Difference (L Value)

A Lab color space is a color-opponent space with dimension L for lightness. L* represents the darkest black at L*=0, and the brightest white at L*=100. In the context of the present invention L value is also referred to as color difference.

### Detergent Adjunct Ingredient

The detergent adjunct ingredient is different to the biosurfactants of this invention. The precise nature of these additional adjunct components, and levels of incorporation thereof, will depend on the physical form of the composition and the nature of the operation for which it is to be used. Suitable adjunct materials include, but are not limited to the components described below such as surfactants, flocculating aid, chelating agents, dye transfer inhibitors, enzymes, enzyme stabilizers, enzyme inhibitors, catalytic materials, bleach activators, hydrogen peroxide, sources of hydrogen peroxide, preformed peracids, s, s, brighteners, suds suppressors, dyes, perfumes, structure elasticizing agents, fabric softeners, carriers, hydrotropes, builders and co-builders, fabric hueing agents, anti-foaming agents, dispersants, processing aids, solvents, and/or pigments.

### Detergent Composition

The term “detergent composition” refers to compositions that find use in the removal of undesired compounds from items to be cleaned, such as textiles, dishes and hard surfaces. The detergent composition may be used to e.g. clean textiles for both household cleaning and industrial cleaning. The terms encompass any materials/compounds selected for the particular type of cleaning composition desired and the form of the product (e.g., liquid, gel, powder, granulate, paste, bar, or spray compositions) and includes, but is not limited to, detergent compositions (e.g., liquid and/or solid laundry detergents and fine fabric detergents; fabric fresheners; fabric softeners; laundry boosters; and textile and laundry pre-spotters/pre-treatment). In addition to containing the enzyme of the invention, the detergent formulation may contain one or more enzymes (such as amylases, proteases, peroxidases, cellulases, betaglucanases, xyloglucanases, hemicellulases, xanthanases, xanthan lyases, lipases, acyl transferases, phospholipases, esterases, laccases, catalases, aryl esterases, amylases, alpha-amylases, glucoamylases, cutinases, pectinases, keratinases, reductases, oxidases, phenoloxidases, lipoxygenases, ligninases, carrageenases, pullulanases, tannases, arabinosidases, hyaluronidases, chondroitinases, xyloglucanases, xylanases, pectin acetyl esterases, polygalacturonases, rhamnogalacturonases, endo-beta-mannanases, exo-beta-mannanases (GH5 and/or GH26), licheninases, phosphodiesterases, pectin methylesterases, cellobiohydrolases, transglutaminases, nucleases, and combinations thereof, or any mixture thereof), and/or detergent adjunct ingredients such as surfactants, builders, chelators or chelating agents, bleach system or bleach components, polymers (as set forth herein), fabric conditioners, foam boosters, suds suppressors, dyes, perfume, tannish inhibitors, optical brighteners, bactericides, fungicides, soil suspending agents, anti-corrosion agents, enzyme inhibitors or stabilizers, enzyme activators, bluing agents and fluorescent dyes, antioxidants, and solubilizers.

### Dish Wash

The term “dish wash” refers to all forms of washing dishes, e.g. by hand dish wash (HDW) or automatic dish wash (ADW). Washing dishes includes, but is not limited to, the cleaning of all forms of crockery such as plates, cups, glasses, bowls, all forms of cutlery such as spoons, knives, forks and serving utensils as well as ceramics, plastics, metals, china, glass and acrylics.

### Enzyme Detergency Benefit

The term “enzyme detergency benefit” is defined herein as the advantageous effect an enzyme may add to a detergent compared to the same detergent without the enzyme. Important detergency benefits which can be provided by enzymes are stain removal with no or very little visible soils after washing and/or cleaning, prevention or reduction of redeposition of soils released in the washing process (an effect that also is termed anti-redeposition), restoring fully or partly the whiteness of textiles which originally were white but after repeated use and wash have obtained a greyish or yellowish appearance (an effect that also is termed whitening). Also included is the maintenance of whiteness, e.g., the prevention of greying or dullness. Textile care benefits, which are not directly related to catalytic stain removal or prevention of redeposition of soils, are also important for enzyme detergency benefits. Examples of such textile care benefits are prevention or reduction of dye transfer from one fabric to another fabric or another part of the same fabric (an effect that is also termed dye transfer inhibition or anti-backstaining), removal of protruding or broken fibers from a fabric surface to decrease pilling tendencies or remove already existing pills or fuzz (an effect that also is termed anti-pilling), improvement of the fabric-softness, colour clarification of the fabric and removal of particulate soils which are trapped in the fibers of the fabric or garment. Enzymatic bleaching is a further enzyme detergency benefit where the catalytic activity generally is used to catalyze the formation of bleaching components such as hydrogen peroxide or other peroxides.

### Extension

The term “extension” means an addition of one or more amino acids to the amino and/or carboxyl terminus of an enzyme, wherein the extended enzyme has maintained the enzyme activity, e.g. an extended protease maintains protease activity.

### Fragment

The term “fragment” means a polypeptide having one or more (e.g., several) amino acids absent from the amino and/or carboxyl terminus of a mature polypeptide or domain; wherein the fragment has maintained the enzyme activity, e.g. a fragment of a protease maintains protease activity.

### Fungal

In the context of the present invention the term “fungal” in relation to polypeptide (such as an enzyme, e.g. a protease) refers to a polypeptide encoded by and thus directly derivable from the genome of a fungus, where such fungus has not been genetically modified to encode said polypeptide, e.g. by introducing the encoding sequence in the genome by recombinant DNA technology. In the context of the present invention, the term “fungal enzyme” or “polypeptide having enzyme activity obtained from a fungal source” thus refers to a enzyme encoded by and thus directly derivable from the genome of a fungal species, where the fungal species has not been subjected to a genetic modification introducing recombinant DNA encoding said enzyme. Thus, the nucleotide sequence encoding the fungal polypeptide having enzyme activity is a sequence naturally in the genetic background of a fungal species. The fungal polypeptide having enzyme activity encoding by such sequence may also be referred to a wildtype enzyme (or parent enzyme). In a further aspect, the invention provides polypeptides having enzyme activity, wherein said polypeptides are substantially homologous to a fungal enzyme. In the context of the present invention, the term “substantially homologous” denotes a polypeptide having enzyme activity which is at least 80%, preferably at least 85%, more preferably at least 90%, more preferably at least 95%, even more preferably at least 96%, 97%, 98%, and most preferably at least 99% identical to the amino acid sequence of a selected fungal enzyme. The polypeptides being substantially homologous to a fungal enzyme may be included in the detergent of the present invention and/or be used in the methods of the present invention.

### Fusion Polypeptide

The term “fusion polypeptide” is a polypeptide in which one polypeptide is fused at the N-terminus and/or the C-terminus of a variant of the present invention. A fusion polypeptide is produced by fusing two or more polynucleotides together. Techniques for producing fusion polypeptides are known in the art, and include ligating the coding sequences encoding the polypeptides so that they are in frame and that expression of the fusion polypeptide is under control of the same promoter(s) and terminator. Fusion polypeptides may also be constructed using intein technology in which fusion polypeptides are created post-translationally (Cooper et al., 1993, EMBO J. 12:2575-2583; Dawson et al., 1994, Science 266:776-779). A fusion polypeptide can further comprise a cleavage site between the two polypeptides. Upon secretion of the fusion protein, the site is cleaved releasing the two polypeptides. Examples of cleavage sites include, but are not limited to, the sites disclosed in Martin et al., 2003, J. Ind. Microbiol. Biotechnol. 3:568-576; Svetina et al., 2000, J. Biotechnol. 76:245-251; Rasmussen-Wilson et al., 1997, Appl. Environ. Microbiol. 63:3488-3493; Ward et al., 1995, Biotechnology 13:498-503; and Contreras et al., 1991, Biotechnology 9:378-381; Eaton et al., 1986, Biochemistry 25:505-512; Collins-Racie et al., 1995, Biotechnology 13:982-987; Carter et al., 1989, Proteins: Structure, Function, and Genetics 6:240-248; and Stevens, 2003, Drug Discovery World 4:35-48.

### Hard Surface Cleaning

The term “Hard surface cleaning” is defined herein as cleaning of hard surfaces wherein hard surfaces may include floors, tables, walls, roofs etc. as well as surfaces of hard objects such as cars (car wash) and dishes (dish wash). Dish washing includes but are not limited to cleaning of plates, cups, glasses, bowls, cutlery such as spoons, knives, forks, serving utensils, ceramics, plastics, metals, china, glass and acrylics.

### Host Cell

The term “host cell” means any cell type that is susceptible to transformation, transfection, transduction, or the like with a nucleic acid construct or expression vector comprising a polynucleotide of the present invention. The term “host cell” encompasses any progeny of a parent cell that is not identical to the parent cell due to mutations that occur during replication.

### Improved Wash Performance

The term “improved wash performance” is defined herein as a detergent composition, optionally comprising one or more enzymes, displaying an increased wash performance after removal or replacement of one or more ingredients, such as a surfactant, relative to the wash performance of same detergent composition before removal or replacement of one or more ingredients. The improved wash performance can be evaluated in several ways depending on what parameter is relevant to measure, e.g. by increased stain removal, color difference or less redeposition. The term “improved wash performance” includes wash performance in laundry.

### Isolated

The term “isolated” means a substance in a form or environment that does not occur in nature. Non-limiting examples of isolated substances include (1) any non-naturally occurring substance, (2) any substance including, but not limited to, any enzyme, variant, nucleic acid, protein, peptide or cofactor, that is at least partially removed from one or more or all of the naturally occurring constituents with which it is associated in nature; (3) any substance modified by the hand of man relative to that substance found in nature; or (4) any substance modified by increasing the amount of the substance relative to other components with which it is naturally associated (e.g., recombinant production in a host cell; multiple copies of a gene encoding the substance; and use of a stronger promoter than the promoter naturally associated with the gene encoding the substance). An isolated substance may be present in a fermentation broth sample; e.g. a host cell may be genetically modified to express the polypeptide of the invention. The fermentation broth from that host cell will comprise the isolated polypeptide.

### Laundering

The term “laundering” relates to both household laundering and industrial laundering and means the process of treating textiles with a solution containing a cleaning or detergent composition of the present invention. The laundering process can for example be carried out using e.g. a household or an industrial washing machine or can be carried out by hand.

### Malodor

The term “malodor” means an odor which is not desired on clean items. The cleaned item should smell fresh and clean without malodors adhered to the item. One example of malodor is compounds with an unpleasant smell, which may be produced by microorganisms. Another example is unpleasant smells can be sweat or body odor adhered to an item which has been in contact with human or animal. Another example of malodor can be the odor from spices which sticks to items, for example curry or other exotic spices which smells strongly. One way of measuring the ability of an item to adhere malodor is by using Assay II disclosed herein.

### Mannosylerythritol Lipid

Mannosylerythritol lipids (MELs) are a glycolipid class of biosurfactants produced by a variety yeast and fungal strains that exhibit interfacial properties. They are amphiphilic molecules with 4-O-β-d-mannopyranose-erythritol as a hydrophilic moiety and a fatty acid and/or an acetyl group as the hydrophobic moiety. The general structure of the four different MELs is depicted below:

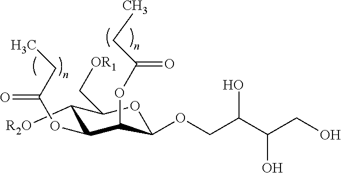

MEL-A: R1/R2=acetyl-; MEL-B: R1=acetyl-, R2=H; MEL-C: R1=H, R2=acetyl-; MEL-D: R1/R2=H with n typically being in the range 4-12, such as 6-10.

A more detailed description can be found in e.g. Kitamoto et al.: Glycolipid Biosurfactants, Mannosylerythritol Lipids: Distinctive Interfacial Properties and Applications in Cosmetic and Personal Care Products (J. Oleo Sci. 71, (1) 1-13 (2022))

### Mature Polypeptide

The term “mature polypeptide” means a polypeptide in its final form following translation and any post-translational modifications, such as N-terminal processing, C-terminal processing (e.g. removal of signal peptide), glycosylation, phosphorylation, etc.

### Mature Polypeptide Coding Sequence

The term “mature polypeptide coding sequence” means a polynucleotide that encodes a mature polypeptide having enzyme activity.

### Nucleic Acid Construct

The term “nucleic acid construct” means a nucleic acid molecule, either single- or double-stranded, which is isolated from a naturally occurring gene or is modified to contain segments of nucleic acids in a manner that would not otherwise exist in nature or which is synthetic, which comprises one or more control sequences.

### Operably Linked

The term “operably linked” means a configuration in which a control sequence is placed at an appropriate position relative to the coding sequence of a polynucleotide such that the control sequence directs expression of the coding sequence.

### Replacing

Replacing (or replacement of) ingredient A fully in a composition with one or more ingredients B, C, D etc. means that ingredient A is no longer part of the composition.

Replacing (or replacement of) ingredient A substantially in a composition with one or more ingredients B, C, D etc. means that the level of ingredient A is reduced so that it no longer has any impact on the relevant performance of the composition, e.g. wash performance.

### Rhamnolipid

Rhamnolipid (RL) is a glycolipid that may be used as a biodegradable surfactant. RL may be in the form of mono-rhamnolipid or di-rhamnolipid, which consist of one or two rhamnose groups respectively, wherein the length of the lipid chain may vary but is typically in the range C₈ to C₁₄, e.g. m,n being 4 to 8.

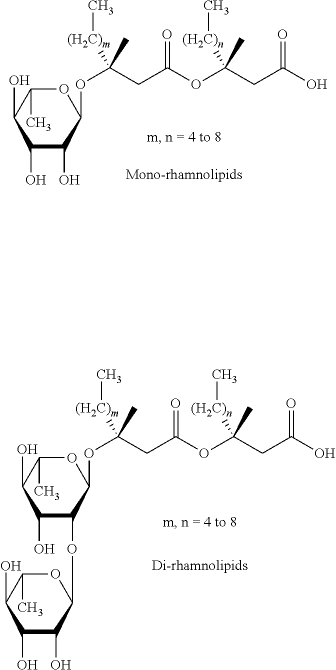

### (Appl Microbiol Biotechnol (2005) 68:718-725)

In the context of the present invention the term “rhamnolipid” includes mono-rhamnolipid or di-rhamnolipid, mixtures thereof and varying lipid chain length as well as salts of rhamnolipid.

### Sequence Identity

Sequence identity may be calculated either by use of Sequence Method 1 or by use of Sequence Method 2

When Sequence Method 1 is applied, the sequence identity between two amino acid sequences is determined as the output of “longest identity” using the Needleman-Wunsch algorithm (Needleman and Wunsch, 1970, J. Mol. Biol. 48:443-453) as implemented in the Needle program of the EMBOSS package (EMBOSS: The European Molecular Biology Open Software Suite, Rice et al., 2000, Trends Genet. 16:276-277), preferably version 6.6.0 or later. The parameters used are a gap open penalty of 10, a gap extension penalty of 0.5, and the EBLOSUM62 (EMBOSS version of BLOSUM62) substitution matrix. In order for the Needle program to report the longest identity, the -nobrief option must be specified in the command line. The output of Needle labeled “longest identity” is calculated as follows:

(Identical Residues×100)/(Length of Alignment−Total Number of Gaps in Alignment)

For purposes of the present invention, the sequence identity between two polynucleotide sequences is determined as the output of “longest identity” using the Needleman-Wunsch algorithm (Needleman and Wunsch, 1970, supra) as implemented in the Needle program of the EMBOSS package (EMBOSS: The European Molecular Biology Open Software Suite, Rice et al., 2000, supra), preferably version 6.6.0 or later. The parameters used are a gap open penalty of 10, a gap extension penalty of 0.5, and the EDNAFULL (EMBOSS version of NCBI NUC4.4) substitution matrix. In order for the Needle program to report the longest identity, the nobrief option must be specified in the command line. The output of Needle labeled “longest identity” is calculated as follows:

(Identical Deoxyribonucleotides×100)/(Length of Alignment−Total Number of Gaps in Alignment).

When Sequence Method 2 is applied, the sequence identity between two amino acid sequences is determined using Needleman-Wunsch algorithm (Needleman and Wunsch, 1970, J. Mol. Biol. 48:443-453) as implemented in the Needle program of the EMBOSS package (EMBOSS: The European Molecular Biology Open Software Suite, Rice et al., 2000, Trends Genet. 16:276-277), preferably version 6.6.0 or later. The parameters used are a gap open penalty of 10, a gap extension penalty of 0.5, and the EBLOSUM62 (EMBOSS version of BLOSUM62) substitution matrix. The percent identity is calculated as follows:

(Identical Residues×100)/(Length of the Alignment)

The sequence identity between two polynucleotide sequences can be determined using the same Needleman-Wunsch algorithm (Needleman and Wunsch, 1970, supra) as implemented in the Needle program of the EMBOSS package (EMBOSS: The European Molecular Biology Open Software Suite, Rice et al., 2000, supra), preferably version 6.6.0 or later. The parameters used are a gap open penalty of 10, a gap extension penalty of 0.5, and the EDNAFULL (EMBOSS version of NCBI NUC4.4) substitution matrix. The percent sequence identity is calculated as follows:

(Identical Deoxyribonucleotides×100)/(Length of the Alignment)

### Sophorolipid

Sophorolipid is a glycolipid that may be used as a biodegradable surfactant. In the context of the present application the term “sophorolipid” include sophorolipid in the lactone form and the corresponding acidic form as well as mixtures thereof, and varying lipid chain length. Further “sophorolipid” also includes salts of sophorolipid.

### Sustainability

Sustainability and sustainable means use of renewable resources that cause little or no damage to the environment and are biodegradable.

### Sustainability Profile

In the context of the present invention the term sustainability profile is used for comparing the sustainability of ingredients (e.g. in a detergent composition) where one or more ingredients can replace other less sustainable ingredients fully or substantially while maintaining the performance of the system (e.g. the performance of a detergent composition during wash of an item).

### Textile

The term “textile” means any textile material including yarns, yarn intermediates, fibers, non-woven materials, natural materials, synthetic materials, and any other textile material, fabrics made of these materials and products made from fabrics (e.g., garments and other articles). The textile or fabric may be in the form of knits, wovens, denims, non-wovens, felts, yarns, and toweling. The textile may be cellulose based such as natural cellulosics, include-ing cotton, flax/linen, jute, ramie, sisal or coir or manmade cellulosics (e.g. originating from wood pulp) including viscose/rayon, cellulose acetate fibers (tricell), lyocell or blends thereof. The textile or fabric may also be non-cellulose based such as natural polyamides including wool, camel, cashmere, mohair, rabbit and silk or synthetic polymers such as nylon, aramid, polyester, acrylic, polypropylene and spandex/elastane, or blends thereof as well as blends of cellulose based and non-cellulose based fibers. Examples of blends are blends of cotton and/or rayon/viscose with one or more companion material such as wool, synthetic fiber (e.g. polyamide fiber, acrylic fiber, polyester fiber, polyvinyl chloride fiber, polyurethane fiber, polyurea fiber, aramid fiber), and/or cellulose-containing fiber (e.g. rayon/viscose, ramie, flax/linen, jute, cellulose acetate fiber, lyocell). Fabric may be conventional washable laundry, for example stained household laundry. When the term fabric or garment is used it is intended to include the broader term textiles as well. In the context of the present invention, the term “textile” also covers fabrics. In the context of the present invention, the term “textile” is used interchangeably with fabric and cloth.

### Used or Worn

The term “used or worn” used herein about a textile means that textile that has been used or worn by a consumer or has been in touch with human skin e.g. during manufacturing or retailing. A consumer can be a person that buys the textile, e.g. a person buying a textile (e.g. new clothes or bedlinen) in a shop or a business that buys the textile (e.g. bed linen, tea towel or table cloth) for use in the business e.g. a hotel, a restaurant, a professional kitchen, an institution, a hospital or the like. In some situations, such used or worn textile bear the conventional stains which has not been thoroughly washed out and can form a gluing base for attracting and accumulating more airborne particulate matter.

### Variant

The term “variant” means a polypeptide having same activity as the parent enzyme comprising an alteration, i.e., a substitution, insertion, and/or deletion, at one or more (e.g., several) positions.

A substitution means replacement of the amino acid occupying a position with a different amino acid; a deletion means removal of the amino acid occupying a position; and an insertion means adding an amino acid adjacent to and immediately following the amino acid occupying a position.

### Wash Cycle

The term “wash cycle” is defined herein as a washing operation wherein textiles are immersed in the wash liquor, mechanical action of some kind is applied to the textile in order to release stains and to facilitate flow of wash liquor in and out of the textile and finally the superfluous wash liquor is removed. After one or more wash cycles, the textile is generally rinsed and dried.

### Wash Liquor

The term “wash liquor” is defined herein as the solution or mixture of water and detergent components optionally including one or more enzymes.

### Wash Performance

The term “wash performance” is used as detergent composition's, enzyme's or polymer's capability to remove stains present on the object to be cleaned or maintain color and whiteness of textile during wash. The improvement in the wash performance may be quantified by REM or delta REM as described in Experimental section.

### Weight Percentage

Weight percentage is abbreviated w/w %, wt % or w %. The abbreviations are used interchangeably.

### Whiteness

The term “Whiteness” is defined herein as a broad term with different meanings in different regions and for different consumers. Whiteness can be on white textiles or be used interchangely as brightness for colored textiles. Loss of whiteness or brightness can e.g. be due to greying, yellowing, or removal of optical brighteners/hueing agents. Greying and yellowing can be due to soil redeposition, stain redeposition, dirt/mud redeposition, pollution particles, body soils, colouring from e.g. iron and copper ions or dye transfer. Loss of whiteness might include one or several issues from the list below: colourant or dye effects; incomplete stain removal (e.g. body soils, sebum etc.); redeposition (greying, yellowing or other discolourations of the object) (removed soils reassociate with other parts of textile, soiled or unsoiled); chemical changes in textile during application; and clarification or brightening of colours.

### DETAILED DESCRIPTION OF THE INVENTION

The present invention concerns detergent composition having improved sustainability profile, wherein the sustainability profile of the detergent composition is improved by replacing the anionic surfactant alkyl benzenesulfonate fully or substantially with a surfactant that can be obtained by fermentation (biosurfactant), wherein the wash performance of the composition is maintained at at least the same level or even improved as when alkyl benzenesulfonate is present in the form of linear alkyl benzenesulfonate (LAS).

Anionic surfactants are the workhorses of laundry detergents and thus difficult to replace. One of the most prominent anionic surfactants is linear alkylbenzene sulfonates (LAS) which contains a spread of chain lengths, but since LAS is based on non-renewable sources and not allowed in products with ecolabels it is important to find alternative anionic surfactant(s) that have a far more sustainable profile. In the pursuit of such alternative to LAS the inventors of the present invention have surprisingly found that a detergent composition having improved sustainability profile can be obtained by replacing LAS fully or substantially with a surfactant that can be obtained by fermentation (biosurfactant) without compromising the performance of the composition. The biosurfactant is preferably selected from the group consisting of rhamnolipid, sophorolipid and mannosylerythritol lipid.

The amount of biosurfactant is typically in the range 1-20% w/w, such as 2-18% w/w, preferably 3-15% w/w, 4-15% w/w or 5-15% w/w, 6-15% w/w, 7-15% w/w, 8-15% w/w, 9-15% w/w or 10-15% w/w. The biosurfactant may be a single biosurfactant, e.g. rhamnolipid, or a combination of two or more biosurfactants, e.g. rhamnolipid and sophorolipid, rhamnolipid and mannosylerythritol lipid, sophorolipid and mannosylerythritol lipid or rhamnolipid, sophorolipid and mannosylerythritol lipid.

The detergent composition may additionally comprise alkyl ethoxysulfate as an (additional) anionic surfactant. The alkyl ethoxysulfates have the advantage that they are environmental friendly and thus compatible with the aim of providing a detergent composition with improved sustainability profile. The detergent composition of the present invention may comprise 1-20 w/w % alkyl ethoxysulfate, such as 2-15 w/w % alkyl ethoxysulfate, such as alkyl ethoxysulfate, such as 2-10 w/w % alkyl ethoxysulfate. Sodium lauryl ether sulfate (SLES) is a preferred alkyl ethoxysulfate. The wash liquor may have a temperature in the range of 5° C. to 95° C., or in the range of 10° C. to 80° C., in the range of 10° C. to 70° C., in the range of 10° C. to 60° C., in the range of 10° C. to 50° C., in the range of 15° C. to 40° C. or in the range of 20° C. to 40° C.

In one embodiment of the invention, the method for laundering an item further comprises draining of the wash liquor or part of the wash liquor after completion of a wash cycle. The wash liquor can then be re-used in a subsequent wash cycle or in a subsequent rinse cycle. The item may be exposed to the wash liquor during a first and optionally a second or a third wash cycle. In one embodiment the item is rinsed after being exposed to the wash liquor. The item can be rinsed with water or with water comprising a conditioner.

The detergent composition of the invention may comprise one or more enzymes, such as amylases, proteases, peroxidases, cellulases, betaglucanases, xyloglucanases, hemicellulases, xanthanases, xanthan lyases, lipases, acyl transferases, phospholipases, esterases, laccases, catalases, aryl esterases, amylases, alpha-amylases, glucoamylases, cutinases, pectinases, keratinases, reductases, oxidases, phenoloxidases, lipoxygenases, ligninases, carrageenases, pullulanases, tannases, arabinosidases, hyaluronidases, chondroitinases, xyloglucanases, xylanases, pectin acetyl esterases, polygalacturonases, rhamnogalacturonases, endo-beta-mannanases, exo-beta-mannanases (GH5 and/or GH26), licheninases, phosphodiesterases, pectin methylesterases, cellobiohydrolases, transglutaminases, nucleases, and combinations thereof, or any mixture thereof. Where the detergent composition comprises one or more enzymes each of the enzymes may be present in an amount corresponding to from 0.0001% to 5% (w/w) active enzyme protein, preferably from 0.001% to 5% (w/w), more preferably from 0.005% to 5% (w/w), more preferably from 0.005% to 4% (w/w), more preferably from 0.005% to 3% (w/w), more preferably from 0.005% to 2% (w/w), even more preferably from 0.01% to 2% (w/w), and most preferably from 0.01% to 1% (w/w) active enzyme protein.

When a protease is present in the detergent formulation, the protease has at least 70%, 80%, 85%, 90%, 91%, 92%, 93%, 94%, 95%, 96%, 97%, 98%, 99%, 99.1%, 99.2%, 99.3%, 99.4%, 99.5%, 99.6%, 99.7%, 99.8%, or 99.9% identity to any of the sequences selected from the group consisting of SEQ ID NO: 1, SEQ ID NO: 2, SEQ ID NO: 3, SEQ ID NO: 4, SEQ ID NO: 5, SEQ ID NO: 6, SEQ ID NO: 7, SEQ ID NO: 8, SEQ ID NO: 9, SEQ ID NO: 10, SEQ ID NO: 11, SEQ ID NO: 12, SEQ ID NO: 13, SEQ ID NO: 14, SEQ ID NO: 15, SEQ ID NO: 16, SEQ ID NO: 17, SEQ ID NO: 18, SEQ ID NO: 19, SEQ ID NO: 20, SEQ ID NO: 21, SEQ ID NO: 22, SEQ ID NO: 23, SEQ ID NO: 24 and SEQ ID NO: 25.

In one aspect the invention concerns use of the detergent composition of the invention, i.e. a detergent composition comprising biosurfactant, such as rhamnolipid, sophorolipid or mannosylerythritol lipid and no or substantially no LAS, for hand dish wash, automated dish wash, hard surface cleaning or laundering. Where the detergent composition is used for laundering of textile in a wash liquor, the wash liquor comprises from about 0.2 g detergent composition/L wash liquor to about 5 g detergent composition/L wash liquor. Preferably the wash performance in laundry wash, as measured by REM or delta REM of an item, is at least maintained, optionally improved when LAS is replaced with biosurfactant after at least one full scale wash cycle.

### Enzymes

The detergent composition may comprise one or more enzymes such as a protease, lipase, cutinase, cellulase, amylase, endoglucanase, carbohydrase, DNase, pectinase, mannanase, arabinase, galactanase, xyloglucanase, xanthanase, oxidase, e.g., a laccase, catalase, and/or peroxidase, or any mixture thereof.

In general, the properties of the selected enzyme(s) should be compatible with the selected detergent, (i.e., pH-optimum, compatibility with other enzymatic and non-enzymatic ingredients, etc.), and the enzyme(s) should be present in effective amounts.

### Cellulases

Suitable cellulases include those of bacterial or fungal origin. Chemically modified or protein engineered mutants are included. Suitable cellulases include cellulases from the genera Bacillus, Pseudomonas, Humicola, Fusarium, Thielavia, Acremonium, e.g., the fungal cellulases produced from Humicola insolens, Myceliophthora thermophila and Fusarium oxysporum disclosed in U.S. Pat. Nos. 4,435,307, 5,648,263, 5,691,178, 5,776,757 and WO 89/09259.

Especially suitable cellulases are the alkaline or neutral cellulases providing or maintaining whiteness and preventing redeposition or having color care benefits. Examples of such cellulases are cellulases described in EP 0 495 257, EP 0 531 372, WO 96/11262, WO 96/29397, WO 98/08940. Other examples are cellulase variants such as those described in WO 94/07998, EP 0 531 315, U.S. Pat. Nos. 5,457,046, 5,686,593, 5,763,254, WO 95/24471, WO 98/12307 and WO99/001544. Other cellulases are endo-beta-1,4-glucanase enzyme having a sequence of at least 97% identity to the amino acid sequence of position 1 to position 773 of SEQ ID NO:2 of WO 2002/099091 or a family 44 xyloglucanase, which a xyloglucanase enzyme having a sequence of at least 60% identity to positions 40-559 of SEQ ID NO: 2 of WO 2001/062903.

Commercially available cellulases include Celluzyme™, and Carezyme™ (Novozymes A/S) Carezyme Premium™ (Novozymes A/S), Celluclean™ (Novozymes A/S), Celluclean Classic™ (Novozymes A/S), Cellusoft™ (Novozymes A/S), Whitezyme™ (Novozymes A/S), Clazinase™, and Puradax HA™ (Genencor International Inc.), and KAC-500 (B)™ (Kao Corporation).

### Deoxyribonucleases (DNases)

The term “DNase” means a polypeptide with DNase activity that catalyzes the hydrolytic cleavage of phosphodiester linkages in the DNA backbone, thus degrading DNA. DNases are also known as phosphodiesterases (PDE). Correspondingly ribonucleases (RNases) catalyzes the hydrolytic cleavage of phosphodiester linkages in the RNA backbone, thus degrading and RNA. There are two primary classifications based on the locus of activity. Exonucleases digest nucleic acids from the ends. Endonucleases act on regions in the middle of target molecules. The nuclease is preferably a DNase, which is preferable is obtainable from a microorganism, preferably a fungi or bacterium. In particular, a DNase which is obtainable from a species of Bacillus is preferred; in particular a DNase which is obtainable from Bacillus cibi, Bacillus subtilis or Bacillus licheniformis is preferred. Examples of such DNases are described in WO 2011/098579, WO2014/087011 and WO2017/060475. Particularly preferred is also a DNase obtainable from a species of Aspergillus; in particular a DNase which is obtainable from Aspergillus oryzae, such as a DNase described in WO 2015/155350.

### Mannanases

Suitable mannanases include those of bacterial or fungal origin. Chemically or genetically modified mutants are included. The mannanase may be an alkaline mannanase of Family 5 or 26. It may be a wild-type from Bacillus or Humicola, particularly B. agaradhaerens, B. licheniformis, B. halodurans, B. clausii, or H. insolens. Suitable mannanases are described in WO 1999/064619. A commercially available mannanase is Mannaway (Novozymes A/S).

### Proteases

Suitable proteases may be of any origin, but are preferably of bacterial or fungal origin, optionally in the form of protein engineered or chemically modified mutants. The protease may be an alkaline protease, such as a serine protease or a metalloprotease. A serine protease may for example be of the S1 family, such as trypsin, or the S8 family such as a subtilisin. A metalloprotease may for example be a thermolysin, e.g. from the M4 family, or another metalloprotease such as those from the M5, M7 or M8 families.

The term “subtilases” refers to a sub-group of serine proteases according to Siezen et al., Protein Eng. 4 (1991) 719-737 and Siezen et al., Protein Sci. 6 (1997) 501-523. Serine proteases are a subgroup of proteases characterized by having a serine in the active site, which forms a covalent adduct with the substrate. The subtilases may be divided into six subdivisions, the Subtilisin family, the Thermitase family, the Proteinase K family, the Lantibiotic peptidase family, the Kexin family and the Pyrolysin family.

Although proteases suitable for detergent use may be obtained from a variety of organisms, including fungi such as Aspergillus, detergent proteases have generally been obtained from bacteria and in particular from Bacillus. Examples of Bacillus species from which subtilases have been derived include Bacillus lentus, Bacillus alkalophilus, Bacillus subtilis, Bacillus amyloliquefaciens, Bacillus licheniformis, Bacillus pumilus and Bacillus gibsonii. Particular subtilisins include subtilisin lentus, subtilisin Novo, subtilisin Carlsberg, subtilisin BPN′, subtilisin 309, subtilisin 147 and subtilisin 168 and e.g. protease PD138 (described in WO 93/18140). Other useful proteases are e.g. those described in WO 01/16285 and WO 02/16547.

Examples of trypsin-like proteases include the Fusarium protease described in WO 94/25583 and WO 2005/040372, and the chymotrypsin proteases derived from Cellumonas described in WO 2005/052161 and WO 2005/052146.

Examples of metalloproteases include the neutral metalloproteases described in WO 2007/044993 such as those derived from Bacillus amyloliquefaciens, as well as e.g. the metalloproteases described in WO 2015/158723 and WO 2016/075078.

Examples of useful proteases are the protease variants described in WO 89/06279 WO 92/19729, WO 96/34946, WO 98/20115, WO 98/20116, WO 99/11768, WO 01/44452, WO 03/006602, WO 2004/003186, WO 2004/041979, WO 2007/006305, WO 2011/036263, WO 2014/207227, WO 2016/087617 and WO 2016/174234. Preferred protease variants may, for example, comprise one or more of the mutations selected from the group consisting of: S3T, V41, S9R, S9E, A15T, S24G, S24R, K27R, N42R, S55P, G59E, G59D, N60D, N60E, V66A, N74D, S85R, A96S, S97G, S97D, S97A, S97SD, S99E, S99D, S99G, S99M, S99N, S99R, S99H, S101A, V1021, V102Y, V102N, S104A, G116V, G116R, H118D, H118N, A120S, S126L, P127Q, S128A, S154D, A156E, G157D, G157P, S158E, Y161A, R164S, Q176E, N179E, S182E, Q185N, A188P, G189E, V193M, N198D, V1991, Q200L, Y203W, S206G, L211Q, L211D, N212D, N212S, M216S, A226V, K229L, Q230H, Q239R, N246K, S253D, N255W, N255D, N255E, L256E, L256D T268A and R269H, wherein position numbers correspond to positions of the Bacillus lentus protease shown in SEQ ID NO: 1 of WO 2016/001449. Protease variants having one or more of these mutations are preferably variants of the Bacillus lentus protease (Savinase®, also known as subtilisin 309) shown in SEQ ID NO: 1 of WO 2016/001449 or of the Bacillus amyloliquefaciens protease (BPN′) shown in SEQ ID NO: 2 of WO 2016/001449. Such protease variants preferably have at least 80% sequence identity to SEQ ID NO: 1 or to SEQ ID NO: 2 of WO 2016/001449.

Another protease of interest is the alkaline protease from Bacillus lentus DSM 5483, as described for example in WO 91/02792, and variants thereof which are described for example in WO 92/21760, WO 95/23221, EP 1921147, EP 1921148 and WO 2016/096711.

The protease may alternatively be a variant of the TY145 protease having SEQ ID NO: 1 of WO 2004/067737, for example a variant comprising a substitution at one or more positions corresponding to positions 27, 109, 111, 171, 173, 174, 175, 180, 182, 184, 198, 199 and 297 of SEQ ID NO: 1 of WO 2004/067737, wherein said protease variant has a sequence identity of at least 75% but less than 100% to SEQ ID NO: 1 of WO 2004/067737. TY145 variants of interest are described in e.g. WO 2015/014790, WO 2015/014803, WO 2015/014804, WO 2016/097350, WO 2016/097352, WO 2016/097357 and WO 2016/097354.

Examples of preferred proteases include:
(a) variants of SEQ ID NO: 1 of WO 2016/001449 comprising two or more substitutions selected from the group consisting of S9E, N43R, N76D, Q206L, Y209W, S259D and L262E, for example a variant with the substitutions S9E, N43R, N76D, V2051, Q206L, Y209W, S259D, N261W and L262E, or with the substitutions S9E, N43R, N76D, N185E, S188E, Q191N, A194P, Q206L, Y209W, S259D and L262E, wherein position numbers are based on the numbering of SEQ ID NO: 2 of WO 2016/001449;
(b) a variant of the polypeptide of SEQ ID NO: 1 of WO 2016/001449 with the mutation S99SE, wherein position numbers are based on the numbering of SEQ ID NO: 2 of WO 2016/001449;
(c) a variant of the polypeptide of SEQ ID NO: 1 of WO 2016/001449 with the mutation S99AD, wherein position numbers are based on the numbering of SEQ ID NO: 2 of WO 2016/001449;
(d) a variant of the polypeptide of SEQ ID NO: 1 of WO 2016/001449 with the substitutions Y167A+R170S+A194P, wherein position numbers are based on the numbering of SEQ ID NO: 2 of WO 2016/001449;
(e) a variant of the polypeptide of SEQ ID NO: 1 of WO 2016/001449 with the substitutions S9R+A15T+V68A+N218D+Q245R, wherein position numbers are based on the numbering of SEQ ID NO: 2 of WO 2016/001449;
(f) a variant of the polypeptide of SEQ ID NO: 1 of WO 2016/001449 with the substitutions S9R+A15T+G61E+V68A+A194P+V2051+Q245R+N261D, wherein position numbers are based on the numbering of SEQ ID NO: 2 of WO 2016/001449;
(g) a variant of the polypeptide of SEQ ID NO: 1 of WO 2016/001449 with the substitutions S99D+S101R/E+S103A+V104I+G160S; for example a variant of SEQ ID NO: 1 of WO 2016/001449 with the substitutions S3T+V41+S99D+S101E+S103A+V104I+G160S+V2051, wherein position numbers are based on the numbering of SEQ ID NO: 2 of WO 2016/001449;
(h) a variant of the polypeptide of SEQ ID NO: 2 of WO 2016/001449 with the substitutions S24G+S53G+S78N+S101N+G128A/S+Y217Q, wherein position numbers are based on the numbering of SEQ ID NO: 2 of WO 2016/001449;
(i) the polypeptide disclosed in GENESEQP under accession number BER84782, corresponding to SEQ ID NO: 302 in WO 2017/210295;
(j) a variant of the polypeptide of SEQ ID NO: 1 of WO 2016/001449 with the substitutions S99D+S101E+S103A+V104I+S156D+G160S+L262E, wherein position numbers are based on the numbering of SEQ ID NO: 2 of WO 2016/001449;
(k) a variant of the polypeptide of SEQ ID NO: 1 of WO 2016/001449 with the substitutions S9R+A15T+G61E+V68A+N76D+S99G+N218D+Q245R, wherein position numbers are based on the numbering of SEQ ID NO: 2 of WO 2016/001449;
(l) a variant of the polypeptide of SEQ ID NO: 1 of WO 2016/001449 with the substitutions V68A+S106A, wherein position numbers are based on the numbering of SEQ ID NO: 2 of WO 2016/001449; and
(m) a variant of the polypeptide of SEQ ID NO: 1 of WO 2004/067737 with the substitutions S27K+N109K+S111E+S171E+S173P+G174K+S175P+F180Y+G182A+L184F+Q198E+N199+T297P, wherein position numbers are based on the numbering of SEQ ID NO: 1 of WO 2004/067737.

Suitable commercially available protease enzymes include those sold under the trade names Alcalase®, Duralase™, Durazym™, Relase®, Relase® Ultra, Savinase®, Savinase® Ultra, Primase™, Polarzyme®, Kannase®, Liquanase®, Liquanase® Ultra, Ovozyme®, Coronase®, Coronase® Ultra, Blaze®, Blaze Evity® 100T, Blaze Evity® 125T, Blaze Evity® 150T, Blaze Evity® 200T, Neutrase®, Everlase®, Esperase®, Progress® Uno, Progress® In and Progress® Excel (Novozymes A/S), those sold under the tradename Maxatase™, Maxacal™, Maxapem®, Purafect® Ox, Purafect® OxP, Puramax®, FN2™, FN3™, FN4ex™, Excellase®, Excellenz™ P1000, Excellenz™ P1250, Eraser™, Preferenz® P100, Purafect Prime, Preferenz P110™, Effectenz P1000™, Purafect®, Effectenz P1050™, Purafect® Ox, Effectenz™ P2000, Purafast™, Properase®, Opticlean™ and Optimase® (Danisco/DuPont), BLAP (sequence shown in FIG. 29 of U.S. Pat. No. 5,352,604) and variants hereof (Henkel AG), and KAP (Bacillus alkalophilus subtilisin) from Kao.

### Lipases and Cutinases

Suitable lipases and cutinases include those of bacterial or fungal origin. Chemically modified or protein engineered mutant enzymes are included. Examples include lipase from Thermomyces, e.g. from T. lanuginosus (previously named Humicola lanuginosa) as described in EP258068 and EP305216, cutinase from Humicola, e.g. H. insolens (WO96/13580), lipase from strains of Pseudomonas (some of these now renamed to Burkholderia), e.g. P. alcaligenes or P. pseudoalcaligenes (EP218272), P. cepacia (EP331376), P. sp. strain SD705 (WO95/06720 & WO96/27002), P. wisconsinensis (WO96/12012), GDSL-type Streptomyces lipases (WO10/065455), cutinase from Magnaporthe grisea (WO10/107560), cutinase from Pseudomonas mendocina (U.S. Pat. No. 5,389,536), lipase from Thermobifida fusca (WO11/084412), Geobacillus stearothermophilus lipase (WO11/084417), lipase from Bacillus subtilis (WO11/084599), and lipase from Streptomyces griseus (WO11/150157) and S. pristinaespiralis (WO12/137147).

Other examples are lipase variants such as those described in EP407225, WO92/05249, WO94/01541, WO94/25578, WO95/14783, WO95/30744, WO95/35381, WO95/22615, WO96/00292, WO97/04079, WO97/07202, WO00/34450, WO00/60063, WO01/92502, WO07/87508 and WO09/109500.

Preferred commercial lipase products include include Lipolase 100T/L, Lipex 100T/L, Lipex 105T, Lipex Evity 100L, Lipex Evity 200L (all Novozymes A/S), Preferenz® L 100 (DuPont).

Still other examples are lipases sometimes referred to as acyltransferases or perhydrolases, e.g. acyltransferases with homology to Candida antarctica lipase A (WO10/111143), acyltransferase from Mycobacterium smegmatis (WO05/56782), perhydrolases from the CE 7 family (WO09/67279), and variants of the M. smegmatis perhydrolase in particular the S54V variant used in the commercial product Gentle Power Bleach from Huntsman Textile Effects Pte Ltd (WO10/100028).

### Amylases

Suitable amylases include an alpha-amylase or a glucoamylase and may be of bacterial or fungal origin. Chemically modified or protein engineered mutants are included. Amylases include, for example, alpha-amylases obtained from Bacillus, e.g., a special strain of Bacillus licheniformis, described in more detail in GB 1,296,839.

Suitable amylases include amylases having SEQ ID NO: 2 in WO 95/10603 or variants having 90% sequence identity to SEQ ID NO: 3 thereof. Preferred variants are described in WO 94/02597, WO 94/18314, WO 97/43424 and SEQ ID NO: 4 of WO 99/019467, such as variants with substitutions in one or more of the following positions: 15, 23, 105, 106, 124, 128, 133, 154, 156, 178, 179, 181, 188, 190, 197, 201, 202, 207, 208, 209, 211, 243, 264, 304, 305, 391, 408, and 444.

Different suitable amylases include amylases having SEQ ID NO: 6 in WO 02/010355 or variants thereof having 90% sequence identity to SEQ ID NO: 6. Preferred variants of SEQ ID NO: 6 are those having a deletion in positions 181 and 182 and a substitution in position 193.

Other amylases which are suitable are hybrid alpha-amylase comprising residues 1-33 of the alpha-amylase derived from B. amyloliquefaciens shown in SEQ ID NO: 6 of WO 2006/066594 and residues 36-483 of the B. licheniformis alpha-amylase shown in SEQ ID NO: 4 of WO 2006/066594 or variants having 90% sequence identity thereof.

Other examples are amylase variants such as those described in WO2011/098531, WO2013/001078 and WO2013/001087.

Commercially available amylases are Duramyl™, Termamyl™, Fungamyl™, Stainzyme™, Stainzyme Plus™, Natalase™, Liquozyme X and BAN™ Amplify; Amplify Prime; (from Novozymes A/S), and Rapidase™, Purastar™/Effectenz™, Powerase, Preferenz S1000, Preferenz S100 and Preferenz S110 (from Genencor International Inc./DuPont).

### Peroxidases/Oxidases

Suitable peroxidases/oxidases include those of plant, bacterial or fungal origin. Chemically modified or protein engineered mutants are included. Examples of useful peroxidases include peroxidases from Coprinus, e.g., from C. cinereus, and variants thereof as those described in WO 93/24618, WO 95/10602, and WO 98/15257. Commercially available peroxidases include Guardzyme™ (Novozymes A/S).

A suitable peroxidase is preferably a peroxidase enzyme comprised by the enzyme classification EC 1.11.1.7, as set out by the Nomenclature Committee of the International Union of Biochemistry and Molecular Biology (IUBMB), or any fragment derived therefrom, exhibiting peroxidase activity. Suitable peroxidases also include a haloperoxidase enzyme, such as chloroperoxidase, bromoperoxidase and compounds exhibiting chloroperoxidase or bromoperoxidase activity. Haloperoxidases are classified according to their specificity for halide ions. Chloroperoxidases (E.C. 1.11.1.10) catalyze formation of hypochlorite from chloride ions. The haloperoxidase may be a chloroperoxidase. Preferably, the haloperoxidase is a vanadium haloperoxidase, i.e., a vanadate-containing haloperoxidase. In a preferred method the vanadate-containing haloperoxidase is combined with a source of chloride ion.

Haloperoxidases have been isolated from many different fungi, in particular from the fungus group dematiaceous hyphomycetes, such as Caldariomyces, e.g., C. fumago, Alternaria, Curvularia, e.g., C. verruculosa and C. inaequalis, Drechslera, Ulocladium and Botrytis. Haloperoxidases have also been isolated from bacteria such as Pseudomonas, e.g., P. pyrrocinia and Streptomyces, e.g., S. aureofaciens.

The haloperoxidase may be derivable from Curvularia sp., in particular Curvularia verruculosa or Curvularia inaequalis, such as C. inaequalis CBS 102.42 as described in WO 95/27046; or C. verruculosa CBS 147.63 or C. verruculosa CBS 444.70 as described in WO 97/04102; or from Drechslera hartlebii as described in WO 01/79459, Dendryphiella salina as described in WO 01/79458, Phaeotrichoconis crotalarie as described in WO 01/79461, or Geniculosporium sp. as described in WO 01/79460.

Suitable oxidases include, in particular, any laccase enzyme comprised by the enzyme classification EC 1.10.3.2, or any fragment derived therefrom exhibiting laccase activity, or a compound exhibiting a similar activity, such as a catechol oxidase (EC 1.10.3.1), an o-aminophenol oxidase (EC 1.10.3.4), or a bilirubin oxidase (EC 1.3.3.5).

Preferred laccase enzymes are enzymes of microbial origin. The enzymes may be derived from plants, bacteria or fungi (including filamentous fungi and yeasts).

Suitable examples from fungi include a laccase derivable from a strain of Aspergillus, Neurospora, e.g., N. crassa, Podospora, Botrytis, Collybia, Fomes, Lentinus, Pleurotus, Trametes, e.g., T. villosa and T. versicolor, Rhizoctonia, e.g., R. solani, Coprinopsis, e.g., C. cinerea, C. comatus, C. friesii, and C. plicatilis, Psathyrella, e.g., P. condelleana, Panaeolus, e.g., P. papilionaceus, Myceliophthora, e.g., M. thermophila, Schytalidium, e.g., S. thermophilum, Polyporus, e.g., P. pinsitus, Phlebia, e.g., P. radiata (WO 92/01046), or Coriolus, e.g., C. hirsutus (JP 2238885). Suitable examples from bacteria include a laccase derivable from a strain of Bacillus.

A laccase derived from Coprinopsis or Myceliophthora is preferred; in particular a laccase derived from Coprinopsis cinerea, as disclosed in WO 97/08325; or from Myceliophthora thermophila, as disclosed in WO 95/33836.

### Licheninases

Suitable licheninases (lichenases) include enzymes that catalyse the hydrolysis of the beta-1,4-glucosidic bonds to give beta-glucans. Licheninases (or lichenases) (e.g. EC 3.2.1.73) hydrolyse (1,4)-beta-D-glucosidic linkages in beta-D-glucans containing (1,3)- and (1,4)-bonds and can act on lichenin and cereal beta-D-glucans, but not on beta-D-glucans containing only 1,3- or 1,4-bonds. Examples of such licheninases are described in patent application WO 2017/097866 and in WO 2017/129754.

### Pectinases

Pectinases (pectolytic enzymes) can be classified according to their preferential substrate, highly methyl-esterified pectin or low methyl-esterified pectin and polygalacturonic acid (pectate), and their reaction mechanism, beta-elimination or hydrolysis. Pectinases can be mainly endo-acting, cutting the polymer at random sites within the chain to give a mixture of oligomers, or they may be exo-acting, attacking from one end of the polymer and producing monomers or dimers. Several pectinase activities acting on the smooth regions of pectin are included in the classification of enzymes provided by the Enzyme Nomenclature (1992) such as pectate lyase (EC 4.2.2.2), pectin lyase (EC 4.2.2.10), polygalacturonase (EC 3.2.1.15), exo-polygalacturonase (EC 3.2.1.67), exo-polygalacturonate lyase (EC 4.2.2.9) and exo-poly-alpha-galacturonosidase (EC 3.2.1.82).

### Xyloglucanases

Xyloglucanases catalyze hydrolysis of xyloglucan. The reaction involves endo hydrolysis of 1,4-beta-D-glucosidic linkages in xyloglucan. For purposes of the present invention, xyloglucanase activity is determined using AZCL-xyloglucan (from Megazyme) as the reaction substrate. The assay can be performed in several ways, e as described in WO 01/62903. One unit of xyloglucanase activity (XyloU) is defined by reference to the assay method described in WO 01/62903, page 60, lines 3-17.

### Microorganisms

The detergent composition, as well as the enzyme formulations described below, may comprise one or more microorganisms or microbes. Generally, any microorganism(s) may be used in the enzyme/detergent formulations in any suitable amount(s)/concentration(s). Microorganisms may be used as the only biologically active ingredient, but they may also be used in conjunction with one or more of the enzymes described above.

The purpose of adding the microorganism(s) may, for example, be to reduce malodor as described in WO 2012/112718. Other purposes could include in-situ production of desirable biological compounds, or inoculation/population of a locus with the microorganism(s) to competitively prevent other non-desirable microorganisms form populating the same locus (competitive exclusion).

The term “microorganism” generally means small organisms that are visible through a microscope. Microorganisms often exist as single cells or as colonies of cells. Some microorganisms may be multicellular. Microorganisms include prokaryotic (e.g., bacteria and archaea) and eukaryotic (e.g., some fungi, algae, protozoa) organisms. Examples of bacteria may be Gram-positive bacteria or Gram-negative bacteria. Example forms of bacteria include vegetative cells and endospores. Examples of fungi may be yeasts, molds and mushrooms. Example forms of fungi include hyphae and spores. Herein, viruses may be considered microorganisms.

Microorganisms may be recombinant or non-recombinant. In some examples, the microorganisms may produce various substances (e.g., enzymes) that are useful for inclusion in detergent compositions. Extracts from microorganisms or fractions from the extracts may be used in the detergents. Media in which microorganisms are cultivated or extracts or fractions from the media may also be used in detergents. In some examples, specific of the microorganisms, substances produced by the microorganisms, extracts, media, and fractions thereof, may be specifically excluded from the detergents. In some examples, the microorganisms, or substances produced by, or extracted from, the microorganisms, may activate, enhance, preserve, prolong, and the like, detergent activity or components contained with detergents.

Generally, microorganisms may be cultivated using methods known in the art. The microorganisms may then be processed or formulated in various ways. In some examples, the microorganisms may be desiccated (e.g., lyophilized). In some examples, the microorganisms may be encapsulated (e.g., spray drying). Many other treatments or formulations are possible. These treatments or preparations may facilitate retention of microorganism viability over time and/or in the presence of detergent components. In some examples, however, microorganisms in detergents may not be viable. The processed/formulated microorganisms may be added to detergents prior to, or at the time the detergents are used.

In one embodiment, the microorganism is a species of Bacillus, for example, at least one species of Bacillus selected from the group consisting of Bacillus subtilis, Bacillus amyloliquefaciens, Bacillus licheniformis, Bacillus atrophaeus, Bacillus pumilus, Bacillus megaterium, or a combination thereof. In a preferred embodiment, the aforementioned Bacillus species are on an endospore form, which significantly improves the storage stability.

### Liquid Enzyme Formulations

The enzymes (proteases or other enzymes included in the detergent) may be formulated as a liquid enzyme formulation, which is generally a pourable composition, though it may also have a high viscosity. The physical appearance and properties of a liquid enzyme formulation may vary a lot—for example, they may have different viscosities (gel to water-like), be colored, not colored, clear, hazy, and even with solid particles like in slurries and suspensions. The minimum ingredients are the enzymes and a solvent system to make it a liquid.

The solvent system may comprise water, polyols (such as glycerol, (mono, di, or tri) propylene glycol, (mono, di, or tri)ethylene glycol, sugar alcohol (e.g., sorbitol, mannitol, erythritol, dulcitol, inositol, xylitol or adonitol), polypropylene glycol, and/or polyethylene glycol), ethanol, sugars, and salts. Usually, the solvent system also includes a preservation agent and/or other stabilizing agents.

A liquid enzyme formulation may be prepared by mixing a solvent system and an enzyme concentrate with a desired degree of purity (or enzyme particles to obtain a slurry/suspension).

In an embodiment, the liquid enzyme composition comprises:

(a) at least 0.01% w/w active enzyme protein,
(b) at least 1% w/w biosurfactant, such as rhamnolipid,
(c) at least one anionic surfactant, such as SLES
(c) water, and
(d) optionally a preservation agent.

The enzymes in the liquid composition of the invention may be stabilized using conventional stabilizing agents. Examples of stabilizing agents include, but are not limited to, sugars like glucose, fructose, sucrose, or trehalose; polyols like glycerol, propylene glycol; addition of salt to increase the ionic strength; divalent cations (e.g., Ca²⁺ or Mg²⁺); and enzyme inhibitors, enzyme substrates, or various polymers (e.g., PVP). Selecting the optimal pH for the formulation may be very important for enzyme stability. The optimal pH depends on the specific enzyme but is typically in the range of pH 4-9. In some cases, surfactants like nonionic surfactant (e.g., alcohol ethoxylates) can improve the physical stability of the enzyme formulations.

Slurries or dispersions of enzymes are typically prepared by dispersing small particles of enzymes (e.g., spray-dried particles) in a liquid medium in which the enzyme is sparingly soluble, e.g., a liquid nonionic surfactant or a liquid polyethylene glycol. Powder can also be added to aqueous systems in an amount so not all go into solution (above the solubility limit). Another format is crystal suspensions which can also be aqueous liquids (see for example WO2019/002356). Another way to prepare such dispersion is by preparing water-in-oil emulsions, where the enzyme is in the water phase, and evaporate the water from the droplets. Such slurries/suspension can be physically stabilized (to reduce or avoid sedimentation) by addition of rheology modifiers, such as fumed silica or xanthan gum, typically to get a shear thinning rheology.

### Granular Enzyme Formulations

The enzymes (proteases or other enzymes included in the detergent) may also be formulated as a solid/granular enzyme formulation. Non-dusting granulates may be produced, e.g. as disclosed in U.S. Pat. Nos. 4,106,991 and 4,661,452, and may optionally be coated by methods known in the art. Examples of waxy coating materials are poly(ethylene oxide) products (polyethyleneglycol, PEG) with mean molar weights of 1000 to 20000; ethoxylated nonylphenols having from 16 to 50 ethylene oxide units; ethoxylated fatty alcohols in which the alcohol contains from 12 to 20 carbon atoms and in which there are 15 to 80 ethylene oxide units; fatty alcohols; fatty acids; and monoand di- and triglycerides of fatty acids. Examples of film-forming coating materials suitable for application by fluid bed techniques are given in GB 1483591.

The enzyme may be formulated as a granule for example as a co-granule that combines one or more enzymes or benefit agents (such as MnTACN or other bleaching components). Examples of enzymes that could be included in co-granulates are: lipases, xyloglucanases, perhydrolases, peroxidases, lipoxygenases, laccases, hemicellulases, proteases, care cellulases, cellulases, cellobiose dehydrogenases, xylanases, phospho lipases, esterases, cutinases, pectinases, mannanases, keratinases, reductases, oxidases, phenoloxidases, ligninases, pullulanases, tannases, pentosanases, lichenases glucanases, arabinosidases, hyaluronidase, chondroitinase, amylases, DNAse, and mixtures thereof. Each enzyme will then be present in more granules securing a more uniform distribution of enzymes in the detergent. This also reduces the physical segregation of different enzymes due to different particle sizes. Methods for producing multi-enzyme cogranulate for the detergent industry are disclosed in the IP.com disclosure IPCOM000200739D.

The core of the enzyme granulate may include additional materials such as fillers, fibre materials (cellulose or synthetic fibers), stabilizing agents, solubilising agents, suspension agents, viscosity regulating agents, light spheres, plasticizers, salts, lubricants and fragrances. The core may include binders, such as synthetic polymer, wax, fat, or carbohydrate. The core may comprise a salt of a multivalent cation, a reducing agent, an antioxidant, a peroxide decomposing catalyst and/or an acidic buffer component, typically as a homogenous blend. The core may consist of an inert particle with the enzyme absorbed into it, or applied onto the surface, e.g., by fluid bed coating. The core may have a diameter of 20-2000 μm, particularly 50-1500 μm, 100-1500 μm or 250-1200 μm. The core can be prepared by granulating a blend of the ingredients, e.g., by a method comprising granulation techniques such as crystallization, precipitation, pan-coating, fluid bed coating, fluid bed agglomeration, rotary atomization, extrusion, prilling, spheronization, size reduction methods, drum granulation, and/or high shear granulation. Methods for preparing the core can be found in Handbook of Powder Technology; Particle size enlargement by C. E. Capes; Volume 1; 1980; Elsevier. These methods are well-known in the art and have also been described in international patent application WO2015/028567, pages 3-5, which is incorporated by reference.

The core of the enzyme granule/particle may be surrounded by at least one coating, e.g., to improve the storage stability, to reduce dust formation during handling, or for coloring the granule. The optional coating(s) may include a salt coating, or other suitable coating materials, such as polyethylene glycol (PEG), methyl hydroxy-propyl cellulose (MHPC) and polyvinyl alcohol (PVA). Examples of enzyme granules with multiple coatings are shown in WO 93/07263 and WO 97/23606.

Such coatings are well-known in the art, and have earlier been described in, for example, WO00/01793, WO2001/025412, and WO2015/028567, which are incorporated by reference.

### Encapsulated Enzyme Formulations

The enzymes (proteases or other enzymes included in the detergent) may also be formulated as an encapsulated enzyme formulation (an ‘encapsulate’). This is particularly useful for separating the enzyme from other ingredients when the enzyme is added into, for example, a (liquid) cleaning composition, such as the detergent compositions described below.

Physical separation can be used to solve incompatibility between the enzyme(s) and other components. Incompatibility can arise if the other components are either reactive against the enzyme, or if the other components are substrates of the enzyme. Other enzymes can be substrates of proteases.

The enzyme may be encapsulated in a matrix, preferably a water-soluble or water dispersible matrix (e.g., water-soluble polymer particles), for example as described in WO 2016/023685. An example of a water-soluble polymeric matrix is a matrix composition comprising polyvinyl alcohol. Such compositions are also used for encapsulating detergent compositions in unit-dose formats.

The enzyme may also be encapsulated in core-shell microcapsules, for example as described in WO 2015/144784, or as described in the IP.com disclosure IPCOM000239419D.

Such core-shell capsules can be prepared using a number of technologies known in the art, e.g., by interfacial polymerization using either a water-in-oil or an oil-in-water emulsion, where polymers are crosslinked at the surface of the droplets in the emulsion (the interface between water and oil), thus forming a wall/membrane around each droplet/capsule.

### Formulation of Detergent Products

The detergent composition of the invention may be in any convenient form, e.g., a bar, a homogenous tablet, a tablet having two or more layers, a pouch having one or more compartments, a regular or compact powder, a granule, a paste, a gel, or a regular, compact or concentrated liquid.

Pouches can be configured as single or multicompartments. It can be of any form, shape and material which is suitable for hold the composition, e.g. without allowing the release of the composition to release of the composition from the pouch prior to water contact. The pouch is made from water soluble film which encloses an inner volume. Said inner volume can be divided into compartments of the pouch. Preferred films are polymeric materials preferably polymers which are formed into a film or sheet. Preferred polymers, copolymers or derivates thereof are selected polyacrylates, and water soluble acrylate copolymers, methyl cellulose, carboxy methyl cellulose, sodium dextrin, ethyl cellulose, hydroxyethyl cellulose, hydroxypropyl methyl cellulose, malto dextrin, poly methacrylates, most preferably polyvinyl alcohol copolymers and, hydroxypropyl methyl cellulose (HPMC). Preferably the level of polymer in the film for example PVA is at least about 60%. Preferred average molecular weight will typically be about 20,000 to about 150,000. Films can also be of blended compositions comprising hydrolytically degradable and water soluble polymer blends such as polylactide and polyvinyl alcohol (known under the Trade reference M8630 as sold by MonoSol LLC, Indiana, USA) plus plasticisers like glycerol, ethylene glycerol, propylene glycol, sorbitol and mixtures thereof. The pouches can comprise a solid laundry cleaning composition or part components and/or a liquid cleaning composition or part components separated by the water soluble film. The compartment for liquid components can be different in composition than compartments containing solids: US2009/0011970 A1.

Detergent ingredients can be separated physically from each other by compartments in water dissolvable pouches or in different layers of tablets. Thereby negative storage interaction between components can be avoided. Different dissolution profiles of each of the compartments can also give rise to delayed dissolution of selected components in the wash solution.

A liquid or gel detergent, which is not unit dosed, may be aqueous, typically containing at least 20% by weight and up to 95% water, such as up to about 70% water, up to about 65% water, up to about 55% water, up to about 45% water, up to about 35% water. Other types of liquids, including without limitation, alkanols, amines, diols, ethers and polyols may be included in an aqueous liquid or gel. An aqueous liquid or gel detergent may contain from 0-30% organic solvent. A liquid or gel detergent may be non-aqueous.

### Liquid Detergent Composition

The liquid detergent composition may comprise a microcapsule, and thus form part of, any detergent composition in any form, such as liquid and powder detergents, and soap and detergent bars. In one embodiment, the invention is directed to liquid detergent compositions comprising a microcapsule, as described above, in combination with one or more additional cleaning composition components.

The microcapsule, as described above, may be added to the liquid detergent composition in an amount corresponding to from 0.0001% to 5% (w/w) active enzyme protein (AEP); preferably from 0.001% to 5%, more preferably from 0.005% to 5%, more preferably from 0.005% to 4%, more preferably from 0.005% to 3%, more preferably from 0.005% to 2%, even more preferably from 0.01% to 2%, and most preferably from 0.01% to 1% (w/w) active enzyme protein.

The liquid detergent composition has a physical form, which is not solid (or gas). It may be a pourable liquid, a paste, a pourable gel or a non-pourable gel. It may be either isotropic or structured, preferably isotropic. It may be a formulation useful for washing in automatic washing machines or for hand washing. It may also be a personal care product, such as a shampoo, toothpaste, or a hand soap. The liquid detergent composition may be aqueous, typically containing at least 20% by weight and up to 95% water, such as up to 70% water, up to 50% water, up to 40% water, up to 30% water, or up to 20% water. Other types of liquids, including without limitation, alkanols, amines, diols, ethers and polyols may be included in an aqueous liquid detergent. An aqueous liquid detergent may contain from 0-30% organic solvent. A liquid detergent may even be non-aqueous, wherein the water content is below 10%, preferably below 5%.

Detergent ingredients can be separated physically from each other by compartments in water dissolvable pouches. Thereby negative storage interaction between components can be avoided. Different dissolution profiles of each of the compartments can also give rise to delayed dissolution of selected components in the wash solution.

The detergent composition may take the form of a unit dose product. A unit dose product is the packaging of a single dose in a non-reusable container. It is increasingly used in detergents for laundry. A detergent unit dose product is the packaging (e.g., in a pouch made from a water-soluble film) of the amount of detergent used for a single wash.

Pouches can be of any form, shape and material which is suitable for holding the composition, e.g., without allowing the release of the composition from the pouch prior to water contact. The pouch is made from water soluble film which encloses an inner volume. Said inner volume can be divided into compartments of the pouch. Preferred films are polymeric materials preferably polymers which are formed into a film or sheet. Preferred polymers, copolymers or derivates thereof are selected polyacrylates, and water-soluble acrylate copolymers, methyl cellulose, carboxy methyl cellulose, sodium dextrin, ethyl cellulose, hydroxyethyl cellulose, hydroxypropyl methyl cellulose, maltodextrin, polymethacrylates, most preferably polyvinyl alcohol copolymers and, hydroxypropyl methyl cellulose (HPMC). Preferably the level of polymer in the film for example PVA is at least about 60%. Preferred average molecular weight will typically be about 20,000 to about 150,000. Films can also be a blend composition comprising hydrolytically degradable and water-soluble polymer blends such as polyactide and polyvinyl alcohol (known under the Trade reference M8630 as sold by Chris Craft In. Prod. Of Gary, Ind., US) plus plasticizers like glycerol, ethylene glycerol, Propylene glycol, sorbitol and mixtures thereof. The pouches can comprise a solid laundry cleaning composition or part components and/or a liquid cleaning composition or part components separated by the water-soluble film. The compartment for liquid components can be different in composition than compartments containing solids (see e.g., US 2009/0011970).

The choice of detergent components may include, for textile care, the consideration of the type of textile to be cleaned, the type and/or degree of soiling, the temperature at which cleaning is to take place, and the formulation of the detergent product. Although components mentioned below are categorized by general header according to a particular functionality, this is not to be construed as a limitation, as a component may comprise additional functionalities as will be appreciated by the skilled artisan.

The choice of additional components is within the skill of the artisan and includes conventional ingredients, including the exemplary non-limiting components set forth below.

### Surfactants

The cleaning composition may comprise one or more surfactants, which may be anionic and/or cationic and/or non-ionic and/or semi-polar and/or zwitterionic, or a mixture thereof. In a particular embodiment, the detergent composition includes a surfactant system (comprising more than one surfactant) e.g. a mixture of one or more nonionic surfactants and one or more anionic surfactants. In one embodiment the detergent comprises at least one anionic surfactant and at least one non-ionic surfactant, the weight ratio of anionic to nonionic surfactant may be from 20:1 to 1:20. In one embodiment the amount of anionic surfactant is higher than the amount of non-ionic surfactant e.g. the weight ratio of anionic to non-ionic surfactant may be from 10:1 to 1.1:1 or from 5:1 to 1.5:1. The amount of anionic to non-ionic surfactant may also be equal and the weight ratios 1:1. In one embodiment the amount of non-ionic surfactant is higher than the amount of anionic surfactant and the weight ratio may be 1:10 to 1:1.1. Preferably the weight ratio of anionic to non-ionic surfactant is from 10:1 to 1:10, such as from 5:1 to 1:5, or from 5:1 to 1:1.2. Preferably, the weight fraction of non-ionic surfactant to anionic surfactant is from 0 to 0.5 or 0 to 0.2 thus non-ionic surfactant can be present or absent if the weight fraction is 0, but if non-ionic surfactant is present, then the weight fraction of the nonionic surfactant is preferably at most 50% or at most 20% of the total weight of anionic surfactant and non-ionic surfactant. Light duty detergent usually comprises more nonionic than anionic surfactant and there the fraction of non-ionic surfactant to anionic surfactant is preferably from 0.5 to 0.9. The total weight of surfactant(s) is typically present at a level of from about 0.1% to about 60% by weight, such as about 1% to about 40%, or about 3% to about 20%, or about 3% to about 10%. The surfactant(s) is chosen based on the desired cleaning application, and may include any conventional surfactant(s) known in the art. When included therein the detergent will usually contain from about 1% to about 40% by weight of an anionic surfactant, such as from about 5% to about 30%, including from about 5% to about 15%, or from about 15% to about 20%, or from about 20% to about 25% of an anionic surfactant. Non-limiting examples of anionic surfactants include sulfates and sulfonates, typically available as sodium or potassium salts or salts of monoethanolamine (MEA, 2-aminoethan-1-ol) or triethanolamine (TEA, 2,2′,2″-nitrilotriethan-1-ol); olefin sulfonates, in particular alpha-olefinsulfonates (AOS); alkyl sulfates (AS), in particular fatty alcohol sulfates (FAS), i.e., primary alcohol sulfates (PAS) such as dodecyl sulfate (SLS); alcohol ethersulfates (AES or AEOS or FES, also known as alcohol ethoxysulfates or fatty alcohol ether sulfates), preferred alcohol ethersulfates include sodium lauryl ether sulfate (SLES); paraffin sulfonates (PS) including alkane-1-sulfonates and secondary alkanesulfonates (SAS); ester sulfonates, including sulfonated fatty acid glycerol esters and alpha-sulfo fatty acid methyl esters (alpha-SFMe or SES or MES); alkyl- or alkenylsuccinic acids such as dodecenyl/tetradecenyl succinic acid (DTSA); diesters and monoesters of sulfosuccinic acid; fatty acid derivatives of amino acids. Anionic surfactants may be added as acids, as salts or as ethanolamine derivatives.

When included therein the detergent will usually contain from about 0.1% to about 40% by weight of a cationic surfactant, for example from about 0.5% to about 30%, in particular from about 1% to about 20%, from about 3% to about 10%, such as from about 3% to about 5%, from about 8% to about 12% or from about 10% to about 12%. Non-limiting examples of cationic surfactants include alkyldimethylethanolamine quat (ADMEAQ), cetyltrimethylammonium bromide (CTAB), dimethyldistearylammonium chloride (DSDMAC), and alkylbenzyldimethylammonium, alkyl quaternary ammonium compounds, alkoxylated quaternary ammonium (AQA) compounds, ester quats, and combinations thereof.

When included therein the detergent will usually contain from about 0.2% to about 40% by weight of a nonionic surfactant, for example from about 0.5% to about 30%, in particular from about 1% to about 20%, from about 3% to about 10%, such as from about 3% to about 5%, from about 8% to about 12%, or from about 10% to about 12%. Non-limiting examples of nonionic surfactants include alcohol ethoxylates (AE or AEO) e.g. the AEO-series such as AEO-7, alcohol propoxylates, in particular propoxylated fatty alcohols (PFA), ethoxylated and propoxylated alcohols, alkoxylated fatty acid alkyl esters, such as ethoxylated and/or propoxylated fatty acid alkyl esters (in particular methyl ester ethoxylates, MEE), alkylpolyglycosides (APG), alkoxylated amines, fatty acid monoethanolamides (FAM), fatty acid diethanolamides (FADA), ethoxylated fatty acid monoethanolamides (EFAM), propoxylated fatty acid monoethanolamides (PFAM), polyhydroxyalkyl fatty acid amides, or N-acyl N-alkyl derivatives of glucosamine (glucamides, GA, or fatty acid glucamides, FAGA), as well as products available under the trade names SPAN and TWEEN, and combinations thereof.

When included therein the detergent will usually contain from about 0.01 to about 10% by weight of a semipolar surfactant. Non-limiting examples of semipolar surfactants include amine oxides (AO) such as alkyldimethylamine oxides, in particular N-(coco alkyl)-N,N-dimethylamine oxide and N-(tallow-alkyl)-N, N-bis(2-hydroxyethyl)amine oxide, and combinations thereof.

When included therein the detergent will usually contain from about 0.01% to about 10% by weight of a zwitterionic surfactant. Non-limiting examples of zwitterionic surfactants include betaines such as alkyldimethylbetaines, sulfobetaines, and combinations thereof.

Additional bio-based surfactants may be used e.g, wherein the surfactant is a non-ionic surfactant which may be hexyl-β-D-maltopyranoside, thiomaltopyranoside or a cyclic-maltopyranoside, such as described in EP2516606 B1, or a manosylerythritol lipid.

### Hydrotropes

A hydrotrope is a compound that solubilises hydrophobic compounds in aqueous solutions (or oppositely, polar substances in a non-polar environment). Typically, hydrotropes have both hydrophilic and a hydrophobic character (so-called amphiphilic properties as known from surfactants); however, the molecular structure of hydrotropes generally do not favor spontaneous self-aggregation, see e.g. review by Hodgdon and Kaler (2007), Current Opinion in Colloid & Interface Science 12:121-128. Hydrotropes do not display a critical concentration above which self-aggregation occurs as found for surfactants and lipids forming miceller, lamellar or other well defined meso-phases. Instead, many hydrotropes show a continuous-type aggregation process where the sizes of aggregates grow as concentration increases. However, many hydrotropes alter the phase behavior, stability, and colloidal properties of systems containing substances of polar and non-polar character, including mixtures of water, oil, surfactants, and polymers. Hydrotropes are classically used across industries from pharma, personal care, food, to technical applications. Use of hydrotropes in detergent compositions allow for example more concentrated formulations of surfactants (as in the process of compacting liquid detergents by removing water) without inducing undesired phenomena such as phase separation or high viscosity.

The detergent may contain 0-10% by weight, for example 0-5% by weight, such as about 0.5 to about 5%, or about 3% to about 5%, of a hydrotrope. Any hydrotrope known in the art for use in detergents may be utilized. Non-limiting examples of hydrotropes include sodium benzenesulfonate, sodium p-toluene sulfonate (STS), sodium xylene sulfonate (SXS), sodium cumene sulfonate (SCS), sodium cymene sulfonate, amine oxides, alcohols and polyglycolethers, sodium hydroxynaphthoate, sodium hydroxynaphthalene sulfonate, sodium ethylhexyl sulfate, and combinations thereof.

### Builders and Co-Builders

The detergent composition may contain about 0-65% by weight, such as about 5% to about 50% of a detergent builder or co-builder, or a mixture thereof. The builder and/or co-builder may particularly be a chelating agent that forms water-soluble complexes with Ca and Mg. Any builder and/or co-builder known in the art for use in cleaning detergents may be utilized.

Non-limiting examples of builders include zeolites, diphosphates (pyrophosphates), triphosphates such as sodium triphosphate (STP or STPP), carbonates such as sodium carbonate, soluble silicates such as sodium metasilicate, layered silicates (e.g., SKS-6 from Clariant), ethanolamines such as 2-aminoethan-1-ol (MEA), diethanolamine (DEA, also known as 2,2′-iminodiethan-1-ol), triethanolamine (TEA, also known as 2,2′,2″-nitrilotriethan-1-ol), and (carboxymethyl) inulin (CMI), and combinations thereof.

The detergent composition may also contain from about 0-50% by weight, such as about 5% to about 30%, of a detergent co-builder. The detergent composition may include a co-builder alone, or in combination with a builder, for example a zeolite builder. Non-limiting examples of co-builders include or copolymers thereof, such as poly(acrylic acid) (PAA) or copoly(acrylic acid/maleic acid) (PAA/PMA). According to the present invention, these components can be included in lower levels than in currently available detergent compositions. Further non-limiting examples include citrate, chelators such as aminocarboxylates, aminopolycarboxylates and phosphonates, and alkyl-or alkenylsuccinic acid. Additional specific examples include 2,2′,2″-nitrilotriacetic acid (NTA), ethylene-diaminetetraacetic acid (EDTA), diethylenetriaminepentaacetic acid (DTPA), iminodisuccinic acid (IDS), ethylenediamine-N,N′-disuccinic acid (EDDS), methylglycinediacetic acid (MGDA), glutamic acid-N,N-diacetic acid (GLDA), 1-hydroxyethane-1,1-diylbis(phosphonic acid (HEDP), ethylenediaminetetramethylenetetrakis(phosphonic acid) (EDTMPA), diethylenetriaminepentamethylenepentakis (phosphonic acid) (DTMPA or DTPMPA), N-(2-hydroxyethyl)iminodiacetic acid (EDG), aspartic acid-N-monoacetic acid (ASMA), aspartic acid-N,N-diacetic acid (ASDA), aspartic acid-N-monopropionic acid (ASMP), iminodisuccinic acid (IDA), N-(2-sulfomethyl) aspartic acid (SMAS), N-(2-sulfoethyl) aspartic acid (SEAS), N-(2-sulfomethyl) glutamic acid (SMGL), N-(2-sulfoethyl) glutamic acid (SEGL), N-methyliminodiacetic acid (MIDA), α-alanine-N,N-diacetic acid (α-ALDA), serine-N,N-diacetic acid (SEDA), isoserine-N,N-diacetic acid (ISDA), phenylalanine-N,N-diacetic acid (PHDA), anthranilic acid-N,N-diacetic acid (ANDA), sulfanilic acid-N,N-diacetic acid (SLDA), taurine-N, N-diacetic acid (TUDA) and sulfomethyl-N,N-diacetic acid (SMDA), N-(2-hydroxyethyl)ethylenediamine-N,N′,N″-triacetic acid (HEDTA), diethanolglycine (DEG), aminotrimethylenetris(phosphonic acid) (ATMP), and combinations and salts thereof. Further exemplary builders and/or co-builders are described in, e.g., WO 09/102854, U.S. Pat. No. 5,977,053

### Bleaching Systems

The cleaning composition may contain 0-50% by weight, such as 1-40%, such as 1-30%, such as about 1% to about 20%, of a bleaching system. Any oxygen-based bleaching system comprising components known in the art for use in cleaning detergents may be utilized. Suitable bleaching system components include sources of hydrogen peroxide; peracids and sources of peracids (bleach activators); and bleach catalysts or boosters.

### Sources of Hydrogen Peroxide:

Suitable sources of hydrogen peroxide are inorganic persalts, including alkali metal salts such as sodium percarbonate and sodium perborates (usually mono- or tetrahydrate), and hydrogen peroxide-urea (1/1).

### Sources of Peracids:

Peracids may be (a) incorporated directly as preformed peracids or (b) formed in situ in the wash liquor from hydrogen peroxide and a bleach activator (perhydrolysis) or (c) formed in situ in the wash liquor from hydrogen peroxide and a perhydrolase and a suitable substrate for the latter, e.g., an ester.

a) Suitable preformed peracids include, but are not limited to, peroxycarboxylic acids such as peroxybenzoic acid and its ring-substituted derivatives, peroxy-α-naphthoic acid, peroxyphthalic acid, peroxylauric acid, peroxystearic acid, -phthalimidoperoxycaproic acid [phthalimidoperoxyhexanoic acid (PAP)], and o-carboxybenzamidoperoxycaproic acid; aliphatic and aromatic diperoxydicarboxylic acids such as diperoxydodecanedioic acid, diperoxyazelaic acid, diperoxysebacic acid, diperoxybrassylic acid, 2-decyldiperoxybutanedioic acid, and diperoxyphthalic, -isophthalic and -terephthalic acids; perimidic acids; peroxymonosulfuric acid; peroxydisulfuric acid; peroxyphosphoric acid; peroxysilicic acid; and mixtures of said compounds. It is understood that the peracids mentioned may in some cases be best added as suitable salts, such as alkali metal salts (e.g., Oxone®) or alkaline earth-metal salts.

b) Suitable bleach activators include those belonging to the class of esters, amides, imides, nitriles or anhydrides and, where applicable, salts thereof. Suitable examples are tetraacetylethylenediamine (TAED), sodium 4-[(3,5,5-trimethylhexanoyl)oxy]benzene-1-sulfonate (ISONOBS), sodium 4-(dodecanoyloxy)benzene-1-sulfonate (LOBS), sodium 4-(decanoyloxy)benzene-1-sulfonate, 4-(decanoyloxy)benzoic acid (DOBA), sodium 4-(nonanoyloxy)benzene-1-sulfonate (NOBS), and/or those disclosed in WO98/17767. A particular family of bleach activators of interest was disclosed in EP624154 and particularly preferred in that family is acetyl triethyl citrate (ATC). ATC or a short chain triglyceride like triacetin has the advantage that they are environmentally friendly. Furthermore, acetyl triethyl citrate and triacetin have good hydrolytical stability in the product upon storage and are efficient bleach activators. Finally, ATC is multifunctional, as the citrate released in the perhydrolysis reaction may function as a builder.

### Bleach Catalysts and Boosters

The bleaching system may also include a bleach catalyst or booster. Some non-limiting examples of bleach catalysts that may be used in the compositions of the present invention include manganese oxalate, manganese acetate, manganese-collagen, cobalt-amine catalysts and manganese triazacyclononane (MnTACN) catalysts; particularly preferred are complexes of manganese with 1,4,7-trimethyl-1,4,7-triazacyclononane (Me3-TACN) or 1,2,4,7-tetramethyl-1,4,7-triazacyclononane (Me4-TACN), in particular Me3-TACN, such as the dinuclear manganese complex [(Me3-TACN)Mn(O)3Mn(Me3-TACN)](PF6)2, and [2,2′,2″-nitrilotris(ethane-1,2-diylazanylylidene-κN-methanylylidene)triphenolato-κ3O]manganese (III). The bleach catalysts may also be other metal compounds, such as iron or cobalt complexes.

In some embodiments, where a source of a peracid is included, an organic bleach catalyst or bleach booster may be used having one of the following formulae:

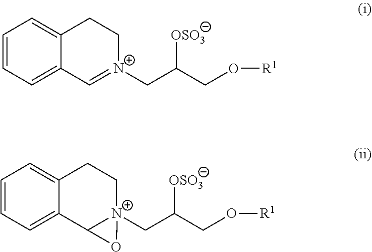

(iii) and mixtures thereof; wherein each R1 is independently a branched alkyl group containing from 9 to 24 carbons or linear alkyl group containing from 11 to 24 carbons, preferably each R1 is independently a branched alkyl group containing from 9 to 18 carbons or linear alkyl group containing from 11 to 18 carbons, more preferably each R1 is independently selected from the group consisting of 2-propylheptyl, 2-butyloctyl, 2-pentylnonyl, 2-hexyldecyl, dodecyl, tetradecyl, hexadecyl, octadecyl, isononyl, isodecyl, isotridecyl and isopentadecyl.

Other exemplary bleaching systems are described, e.g. in WO2007/087258, WO2007/087244, WO2007/087259, EP1867708 (Vitamin K) and WO2007/087242. Suitable photobleaches may for example be sulfonated zinc or aluminium phthalocyanines.

### Polymers and Dispersants

Generally, detergent compositions may contain 0-10% by weight, such as 0.5-5%, 2-5%, 0.5-2% or 0.2-1% of a polymer. Any polymer known in the art for use in detergents may be utilized. The polymer may function as a co-builder as mentioned above, or may provide anti-redeposition, fiber protection, soil release, dye transfer inhibition, grease cleaning and/or anti-foaming properties. Some polymers may have more than one of the above-mentioned properties and/or more than one of the below-mentioned motifs. Exemplary polymers include poly(vinyl alcohol) (PVA), poly(vinylpyrrolidone) (PVP), poly(ethyleneglycol) or poly(ethylene oxide) (PEG), ethoxylated poly(ethyleneimine), carboxymethyl inulin (CMI), and silicones, copolymers of terephthalic acid and oligomeric glycols, copolymers of poly(ethylene terephthalate) and poly(oxyethene terephthalate) (PET-POET), PVP, poly(vinylimidazole) (PVI), poly(vinylpyridine-N-oxide) (PVPO or PVPNO) and polyvinylpyrrolidone-vinylimidazole (PVPVI). Further exemplary polymers include polyethylene oxide and polypropylene oxide (PEO-PPO), diquaternium ethoxy sulfate, styrene/acrylic copolymer and perfume capsules Other exemplary polymers are disclosed in, e.g., WO 2006/130575. Salts of the above-mentioned polymers are also contemplated.

The detergent compositions of the present invention can also contain dispersants. In particular powdered detergents may comprise dispersants. Suitable water-soluble organic materials include the homo- or co-polymeric acids or their salts, in which the polycarboxylic acid comprises at least two carboxyl radicals separated from each other by not more than two carbon atoms. Suitable dispersants are for example described in Powdered Detergents, Surfactant science series volume 71, Marcel Dekker, Inc.

According to the present invention, however, certain of the above polymers, namely, a polyacrylic acid, a modified polyacrylic acid polymer, a modified polyacrylic acid copolymer, a maleic acid-acrylic acid copolymer, carboxymethyl cellulose, cellulose gum, methyl cellulose, and/or combinations thereof, can be included in lower levels than in currently available detergent compositions, or even more preferably, excluded altogether.

### Fabric Hueing Agents

The detergent compositions of the present invention may also include fabric hueing agents such as dyes or pigments, which when formulated in detergent compositions can deposit onto a fabric when said fabric is contacted with a wash liquor comprising said detergent compositions and thus altering the tint of said fabric through absorption/reflection of visible light. Fluorescent whitening agents emit at least some visible light. In contrast, fabric hueing agents alter the tint of a surface as they absorb at least a portion of the visible light spectrum. Suitable fabric hueing agents include dyes and dye-clay conjugates and may also include pigments. Suitable dyes include small molecule dyes and polymeric dyes. Suitable small molecule dyes include small molecule dyes selected from the group consisting of dyes falling into the Colour Index (C.I.) classifications of Direct Blue, Direct Red, Direct Violet, Acid Blue, Acid Red, Acid Violet, Basic Blue, Basic Violet and Basic Red, or mixtures thereof, for example as described in WO2005/03274, WO2005/03275, WO2005/03276 and EP1876226 (hereby incorporated by reference). The detergent composition preferably comprises from about 0.00003 wt % to about 0.2 wt %, from about 0.00008 wt % to about 0.05 wt %, or even from about 0.0001 wt % to about 0.04 wt % fabric hueing agent. The composition may comprise from 0.0001 wt % to 0.2 wt % fabric hueing agent, this may be especially preferred when the composition is in the form of a unit dose pouch. Suitable hueing agents are also disclosed in, e.g. WO 2007/087257 and WO2007/087243.

### Laundry Soap Bars

The detergent of the invention may be in the form of a laundry soap bar and used for hand washing laundry, fabrics and/or textiles. The term laundry soap bar includes laundry bars, soap bars, combo bars, syndet bars and detergent bars. The types of bar usually differ in the type of surfactant they contain, and the term laundry soap bar includes those containing soaps from fatty acids and/or synthetic soaps. The laundry soap bar has a physical form which is solid and not a liquid, gel or a powder at room temperature. The term solid is defined as a physical form which does not significantly change over time, i.e. if a solid object (e.g. laundry soap bar) is placed inside a container, the solid object does not change to fill the container it is placed in. The bar is a solid typically in bar form but can be in other solid shapes such as round or oval.

The laundry soap bar may contain one or more additional enzymes, protease inhibitors such as peptide aldehydes (or hydrosulfite adduct or hemiacetal adduct), boric acid, borate, borax and/or phenylboronic acid derivatives such as 4-formylphenylboronic acid, one or more soaps or synthetic surfactants, polyols such as glycerine, pH controlling compounds such as fatty acids, citric acid, acetic acid and/or formic acid, and/or a salt of a monovalent cation and an organic anion wherein the monovalent cation may be for example Na⁺, K⁺ or NH₄⁺ and the organic anion may be for example formate, acetate, citrate or lactate such that the salt of a monovalent cation and an organic anion may be, for example, sodium formate.

The laundry soap bar may also contain complexing agents like EDTA and HEDP, perfumes and/or different type of fillers, surfactants e.g. anionic synthetic surfactants, builders, polymeric soil release agents, detergent chelators, stabilizing agents, fillers, dyes, colorants, dye transfer inhibitors, alkoxylated polycarbonates, suds suppressers, structurants, binders, leaching agents, bleaching activators, clay soil removal agents, anti-redeposition agents, polymeric dispersing agents, brighteners, fabric softeners, perfumes and/or other compounds known in the art.

The laundry soap bar may be processed in conventional laundry soap bar making equipment such as, but not limited to, mixers, plodders, e.g. a two-stage vacuum plodder, extruders, cutters, logo-stampers, cooling tunnels and wrappers. The invention is not limited to preparing the laundry soap bars by any single method. The premix of the invention may be added to the soap at different stages of the process. For example, the premix containing a soap, xyloglucanase, optionally one or more additional enzymes, a protease inhibitor, and a salt of a monovalent cation and an organic anion may be prepared, and the mixture is then plodded. The xyloglucanase and optional additional enzymes may be added at the same time as the protease inhibitor for example in liquid form. Besides the mixing step and the plodding step, the process may further comprise the steps of milling, extruding, cutting, stamping, cooling and/or wrapping.

### PREFERRED EMBODIMENTS

1. A detergent composition having improved sustainability profile, wherein the sustainability profile of the detergent composition is improved by replacing alkylbenzene sulfonate fully or substantially with a surfactant that can be obtained by fermentation (biosurfactant), wherein the wash performance of the composition is maintained at at least the same level as when alkyl benzenesulfonate is present in the form of linear alkyl benzenesulfonate (LAS).

2. The detergent composition according to Embodiment 1, wherein the biosurfactant is selected from the group consisting of rhamnolipid, sophorolipid and mannosylerythritol lipids and the detergent composition further comprises alkyl ethoxysulfate, such as sodium lauryl ether sulfate.

3. The detergent composition according to Embodiment 1 or 2 further comprising a protease

4. The detergent composition according to Embodiment 3, wherein the protease is selected from the group consisting of metalloproteases, serine protease, aspartic protease, cysteine protease, amino peptidase and carboxy peptidase.

5. The detergent composition according to Embodiment 4, wherein the protease is a metalloprotease or a serine protease.

6. The detergent composition according to any of Embodiments 3 to 5, wherein the protease has an amino acid sequence having at least 60%, at least 65%, at least 70%, at least 75%, at least 80%, at least 85%, at least 90%, at least 95%, at least 96%, at least 97%, at least 98%, at least 99% or even 100% sequence identity to any of the sequences selected from the group consisting of SEQ ID NO: 1, SEQ ID NO: 2, SEQ ID NO: 3, SEQ ID NO: 4, SEQ ID NO: 5, SEQ ID NO: 6, SEQ ID NO: 7, SEQ ID NO: 8, SEQ ID NO: 9, SEQ ID NO: 10, SEQ ID NO: 11, SEQ ID NO: 12, SEQ ID NO: 13, SEQ ID NO: 14, SEQ ID NO: 15, SEQ ID NO: 16, SEQ ID NO: 17, SEQ ID NO: 18, SEQ ID NO: 19, SEQ ID NO: 20, SEQ ID NO: 21, SEQ ID NO: 22, SEQ ID NO: 23, SEQ ID NO: 24, SEQ ID NO: 25 and SEQ ID NO: 26.

7. The detergent composition according to any of the proceeding embodiments comprising a protease and at least one additional enzyme, wherein the at least one additional enzyme is selected from the group consisting of cellulase, amylase, deoxyribonuclease, lipase, xyloglucanase, cutinase, pectinase, xanthanases, peroxidase, haloperoxygenases, catalase and mannanase.

8. The detergent composition according to any of the preceding embodiments, wherein the protease and/or the at least one additional enzyme is present in the detergent composition in an amount corresponding to from 0.0001% to 5% (w/w) active enzyme protein.

9. Use of the detergent composition according to any of the preceding embodiments for hand dish wash, automated dish wash, hard surface cleaning or laundering.

10. The use according to Embodiment 9, wherein the wash performance in laundry wash, as measured by REM or delta REM of an item is at least maintained, optionally improved when LAS is replaced with biosurfactant after at least one full scale wash cycle.

11. The detergent composition according to any of Embodiments 1 to 8 or the use according to Embodiments 9 or 10, wherein the detergent composition comprises 1-20% (w/w) rhamnolipid.

12. The detergent composition according to any of Embodiments 1 to 8, 11 or the use according to Embodiments 9 or 10, wherein the detergent composition comprises 1-20% (w/w) alkyl ethersulfate.

13. The detergent composition according to any of Embodiments 1 to 8, 11 or the use according to Embodiments 9 or 10, wherein the detergent composition comprises a protease having at least 60%, at least 65%, at least 70%, at least 75%, at least 80%, at least 85%, at least 90%, at least 95%, at least 96%, at least 97%, at least 98%, at least 99% or even 100% sequence identity to SEQ ID NO: 1 and at least one biosurfactant selected from the group consisting of rhamnolipid, sophorolipid and mannosylerythritol lipids.

14. The detergent composition according to any of Embodiments 1 to 8, 11 or the use according to Embodiments 9 or 10, wherein the detergent composition comprises a protease having at least 60%, at least 65%, at least 70%, at least 75%, at least 80%, at least 85%, at least 90%, at least 95%, at least 96%, at least 97%, at least 98%, at least 99% or even 100% sequence identity to SEQ ID NO: 2 and at least one biosurfactant selected from the group consisting of rhamnolipid, sophorolipid and mannosylerythritol lipids.

15. The detergent composition according to any of Embodiments 1 to 8, 11 or the use according to Embodiments 9 or 10, wherein the detergent composition comprises a protease having at least 60%, at least 65%, at least 70%, at least 75%, at least 80%, at least 85%, at least 90%, at least 95%, at least 96%, at least 97%, at least 98%, at least 99% or even 100% sequence identity to SEQ ID NO: 3 and at least one biosurfactant selected from the group consisting of rhamnolipid, sophorolipid and mannosylerythritol lipids.

16. The detergent composition according to any of Embodiments 1 to 8, 11 or the use according to Embodiments 9 or 10, wherein the detergent composition comprises a protease having at least 60%, at least 65%, at least 70%, at least 75%, at least 80%, at least 85%, at least 90%, at least 95%, at least 96%, at least 97%, at least 98%, at least 99% or even 100% sequence identity to SEQ ID NO: 4 and at least one biosurfactant selected from the group consisting of rhamnolipid, sophorolipid and mannosylerythritol lipids.

17. The detergent composition according to any of Embodiments 1 to 8, 11 or the use according to Embodiments 9 or 10, wherein the detergent composition comprises a protease having at least 60%, at least 65%, at least 70%, at least 75%, at least 80%, at least 85%, at least 90%, at least 95%, at least 96%, at least 97%, at least 98%, at least 99% or even 100% sequence identity to SEQ ID NO: 5 and at least one biosurfactant selected from the group consisting of rhamnolipid, sophorolipid and mannosylerythritol lipids.

18. The detergent composition according to any of Embodiments 1 to 8, 11 or the use according to Embodiments 9 or 10, wherein the detergent composition comprises a protease having at least 60%, at least 65%, at least 70%, at least 75%, at least 80%, at least 85%, at least 90%, at least 95%, at least 96%, at least 97%, at least 98%, at least 99% or even 100% sequence identity to SEQ ID NO: 6 and at least one biosurfactant selected from the group consisting of rhamnolipid, sophorolipid and mannosylerythritol lipids.

19. The detergent composition according to any of Embodiments 1 to 8, 11 or the use according to Embodiments 9 or 10, wherein the detergent composition comprises a protease having at least 60%, at least 65%, at least 70%, at least 75%, at least 80%, at least 85%, at least 90%, at least 95%, at least 96%, at least 97%, at least 98%, at least 99% or even 100% sequence identity to SEQ ID NO: 7 and at least one biosurfactant selected from the group consisting of rhamnolipid, sophorolipid and mannosylerythritol lipids.

20. The detergent composition according to any of Embodiments 1 to 8, 11 or the use according to Embodiments 9 or 10, wherein the detergent composition comprises a protease having at least 60%, at least 65%, at least 70%, at least 75%, at least 80%, at least 85%, at least 90%, at least 95%, at least 96%, at least 97%, at least 98%, at least 99% or even 100% sequence identity to SEQ ID NO: 8 and at least one biosurfactant selected from the group consisting of rhamnolipid, sophorolipid and mannosylerythritol lipids.

21. The detergent composition according to any of Embodiments 1 to 8, 11 or the use according to Embodiments 9 or 10, wherein the detergent composition comprises a protease having at least 60%, at least 65%, at least 70%, at least 75%, at least 80%, at least 85%, at least 90%, at least 95%, at least 96%, at least 97%, at least 98%, at least 99% or even 100% sequence identity to SEQ ID NO: 9 and at least one biosurfactant selected from the group consisting of rhamnolipid, sophorolipid and mannosylerythritol lipids.

22. The detergent composition according to any of Embodiments 1 to 8, 11 or the use according to Embodiments 9 or 10, wherein the detergent composition comprises a protease having at least 60%, at least 65%, at least 70%, at least 75%, at least 80%, at least 85%, at least 90%, at least 95%, at least 96%, at least 97%, at least 98%, at least 99% or even 100% sequence identity to SEQ ID NO: 10 and at least one biosurfactant selected from the group consisting of rhamnolipid, sophorolipid and mannosylerythritol lipids.

23. The detergent composition according to any of Embodiments 1 to 8, 11 or the use according to Embodiments 9 or 10, wherein the detergent composition comprises a protease having at least 60%, at least 65%, at least 70%, at least 75%, at least 80%, at least 85%, at least 90%, at least 95%, at least 96%, at least 97%, at least 98%, at least 99% or even 100% sequence identity to SEQ ID NO: 11 and at least one biosurfactant selected from the group consisting of rhamnolipid, sophorolipid and mannosylerythritol lipids.

24. The detergent composition according to any of Embodiments 1 to 8, 11 or the use according to Embodiments 9 or 10, wherein the detergent composition comprises a protease having at least 60%, at least 65%, at least 70%, at least 75%, at least 80%, at least 85%, at least 90%, at least 95%, at least 96%, at least 97%, at least 98%, at least 99% or even 100% sequence identity to SEQ ID NO: 12 and at least one biosurfactant selected from the group consisting of rhamnolipid, sophorolipid and mannosylerythritol lipids.

25. The detergent composition according to any of Embodiments 1 to 8, 11 or the use according to Embodiments 9 or 10, wherein the detergent composition comprises a protease having at least 60%, at least 65%, at least 70%, at least 75%, at least 80%, at least 85%, at least 90%, at least 95%, at least 96%, at least 97%, at least 98%, at least 99% or even 100% sequence identity to SEQ ID NO: 13 and at least one biosurfactant selected from the group consisting of rhamnolipid, sophorolipid and mannosylerythritol lipids.

26. The detergent composition according to any of Embodiments 1 to 8, 11 or the use according to Embodiments 9 or 10, wherein the detergent composition comprises a protease having at least 60%, at least 65%, at least 70%, at least 75%, at least 80%, at least 85%, at least 90%, at least 95%, at least 96%, at least 97%, at least 98%, at least 99% or even 100% sequence identity to SEQ ID NO: 14 and at least one biosurfactant selected from the group consisting of rhamnolipid, sophorolipid and mannosylerythritol lipids.

27. The detergent composition according to any of Embodiments 1 to 8, 11 or the use according to Embodiments 9 or 10, wherein the detergent composition comprises a protease having at least 60%, at least 65%, at least 70%, at least 75%, at least 80%, at least 85%, at least 90%, at least 95%, at least 96%, at least 97%, at least 98%, at least 99% or even 100% sequence identity to SEQ ID NO: 15 and at least one biosurfactant selected from the group consisting of rhamnolipid, sophorolipid and mannosylerythritol lipids.

28. The detergent composition according to any of Embodiments 1 to 8, 11 or the use according to Embodiments 9 or 10, wherein the detergent composition comprises a protease having at least 60%, at least 65%, at least 70%, at least 75%, at least 80%, at least 85%, at least 90%, at least 95%, at least 96%, at least 97%, at least 98%, at least 99% or even 100% sequence identity to SEQ ID NO: 16 and at least one biosurfactant selected from the group consisting of rhamnolipid, sophorolipid and mannosylerythritol lipids.

29. The detergent composition according to any of Embodiments 1 to 8, 11 or the use according to Embodiments 9 or 10, wherein the detergent composition comprises a protease having at least 60%, at least 65%, at least 70%, at least 75%, at least 80%, at least 85%, at least 90%, at least 95%, at least 96%, at least 97%, at least 98%, at least 99% or even 100% sequence identity to SEQ ID NO: 17 and at least one biosurfactant selected from the group consisting of rhamnolipid, sophorolipid and mannosylerythritol lipids.

30. The detergent composition according to any of Embodiments 1 to 8, 11 or the use according to Embodiments 9 or 10, wherein the detergent composition comprises a protease having at least 60%, at least 65%, at least 70%, at least 75%, at least 80%, at least 85%, at least 90%, at least 95%, at least 96%, at least 97%, at least 98%, at least 99% or even 100% sequence identity to SEQ ID NO: 18 and at least one biosurfactant selected from the group consisting of rhamnolipid, sophorolipid and mannosylerythritol lipids.

31. The detergent composition according to any of Embodiments 1 to 8, 11 or the use according to Embodiments 9 or 10, wherein the detergent composition comprises a protease having at least 60%, at least 65%, at least 70%, at least 75%, at least 80%, at least 85%, at least 90%, at least 95%, at least 96%, at least 97%, at least 98%, at least 99% or even 100% sequence identity to SEQ ID NO: 19 and at least one biosurfactant selected from the group consisting of rhamnolipid, sophorolipid and mannosylerythritol lipids.

32. The detergent composition according to any of Embodiments 1 to 8, 11 or the use according to Embodiments 9 or 10, wherein the detergent composition comprises a protease having at least 60%, at least 65%, at least 70%, at least 75%, at least 80%, at least 85%, at least 90%, at least 95%, at least 96%, at least 97%, at least 98%, at least 99% or even 100% sequence identity to SEQ ID NO: 20 and at least one biosurfactant selected from the group consisting of rhamnolipid, sophorolipid and mannosylerythritol lipids.

33. The detergent composition according to any of Embodiments 1 to 8, 11 or the use according to Embodiments 9 or 10, wherein the detergent composition comprises a protease having at least 60%, at least 65%, at least 70%, at least 75%, at least 80%, at least 85%, at least 90%, at least 95%, at least 96%, at least 97%, at least 98%, at least 99% or even 100% sequence identity to SEQ ID NO: 21 and at least one biosurfactant selected from the group consisting of rhamnolipid, sophorolipid and mannosylerythritol lipids.

34. The detergent composition according to any of Embodiments 1 to 8, 11 or the use according to Embodiments 9 or 10, wherein the detergent composition comprises a protease having at least 60%, at least 65%, at least 70%, at least 75%, at least 80%, at least 85%, at least 90%, at least 95%, at least 96%, at least 97%, at least 98%, at least 99% or even 100% sequence identity to SEQ ID NO: 22 and at least one biosurfactant selected from the group consisting of rhamnolipid, sophorolipid and mannosylerythritol lipids.

35. The detergent composition according to any of Embodiments 1 to 8, 11 or the use according to Embodiments 9 or 10, wherein the detergent composition comprises a protease having at least 60%, at least 65%, at least 70%, at least 75%, at least 80%, at least 85%, at least 90%, at least 95%, at least 96%, at least 97%, at least 98%, at least 99% or even 100% sequence identity to SEQ ID NO: 23 and at least one biosurfactant selected from the group consisting of rhamnolipid, sophorolipid and mannosylerythritol lipids.

36. The detergent composition according to any of Embodiments 1 to 8, 11 or the use according to Embodiments 9 or 10, wherein the detergent composition comprises a protease having at least 60%, at least 65%, at least 70%, at least 75%, at least 80%, at least 85%, at least 90%, at least 95%, at least 96%, at least 97%, at least 98%, at least 99% or even 100% sequence identity to SEQ ID NO: 24 and at least one biosurfactant selected from the group consisting of rhamnolipid, sophorolipid and mannosylerythritol lipids.

37. The detergent composition according to any of Embodiments 1 to 8, 11 or the use according to Embodiments 9 or 10, wherein the detergent composition comprises a protease having at least 60%, at least 65%, at least 70%, at least 75%, at least 80%, at least 85%, at least 90%, at least 95%, at least 96%, at least 97%, at least 98%, at least 99% or even 100% sequence identity to SEQ ID NO: 25 and at least one biosurfactant selected from the group consisting of rhamnolipid, sophorolipid and mannosylerythritol lipids.

38. The detergent composition according to any of Embodiments 1 to 8, 11 or the use according to Embodiments 9 or 10, wherein the detergent composition comprises a protease having at least 60%, at least 65%, at least 70%, at least 75%, at least 80%, at least 85%, at least 90%, at least 95%, at least 96%, at least 97%, at least 98%, at least 99% or even 100% sequence identity to SEQ ID NO: 26 and at least one biosurfactant selected from the group consisting of rhamnolipid, sophorolipid and mannosylerythritol lipids.

### EXAMPLES

### Materials and Methods

Terg-o-tometer (TOM) Wash Assay

The Terg-o-tometer (TOM) is a medium scale wash assay that can be applied to simultaneously test up to 16 different conditions at the same time. Briefly, it consists of 16×2 L metal beakers, each fitted with an agitator, which rotate in a back-and-forth manner at a controlled speed to simulate the agitation occurring in commercial top-loader washing machines. The beakers are partly submerged in thermostatic water baths where the temperature can be controlled. Each beaker was filled with 1L detergent solution, and test swatches, ballast and enzymes are added to the requisite levels. After a timed wash period, the swatches are promptly removed from the beakers and rinsed thoroughly.

The swatches are then spread out flat on a rack covered with filter paper, covered, and allowed to dry overnight at room temperature. All washes are evaluated the day after the wash. Light reflectance evaluations of the swatches are done using a DataColor Model 800V reflectance spectrophotometer. The measurements are made without UV in the incident light and remission (REM) at 460 nm is extracted. Measurements are made on unwashed and washed swatches. The test swatch to be measured is placed on top of another swatch of the same type and color.

The effect of a protease on each swatch is calculated by subtracting the remission value of the swatch washed without protease (blank) from the swatch washed together with protease.

TABLE 1
Detergents and test conditions for TOM wash assay

| Detergents 1-1, 1-2, | Ingredient list: | |
|---|---|---|
| 1-3, 1-4, 2-1, 2-2, | Na-LAS (Alkylbenzene-sulfonic acid) | |
| 2-3, 2-4, 3-1, 3-2, | Rhamnolipid | |
| 3-3, 3-4 according | MPG (Propane-1,2-diol) | |
| to Table 2 | Boric acid | |
| | Sodium citrate | |
| | Phenoxyethanol | |
| | Citric acid | |
| | NaOH | |
| | Water | |
| | pH 8.1 | |
| Detergent dosage | 5 | g/L |
| Test solution | 1 | L |
| volume | | |
| pH in wash | Detergent 1-1: 8.19 | |
| | Detergent 1-2: 8.27 | |
| | Detergent 1-3: 8.30 | |
| | Detergent 1-4: 8.23 | |
| | Detergent 2-1: 8.28 | |
| | Detergent 2-2: 8.23 | |
| | Detergent 2-3: 8.16 | |
| | Detergent 2-4: 8.03 | |
| | Detergent 3-1: 8.08 | |
| | Detergent 3-2: 8.08 | |
| | Detergent 3-3: 8.10 | |
| | Detergent 3-4: 8.09 | |
| Wash time | 20 | minutes |
| Temperature | 20° | C. |

| | |
|---|---|
| Water hardness | 16° dH (Ca²⁺/Mg²⁺/NaHCO₃ ratio 4:1:9.25) |
| Enzyme | 10 nmol/L or 20 nmol/L |
| concentration in | |
| test solution | |
| Test materials | 2 swatches (5 cm × 5 cm) of each stain per |
| | TOM beaker: PC-05 (Blood, Milk, Ink (BMI)), |
| | C-S-07 (Grass, pure), C-S-01 (Blood, aged), |
| | C-S-101 (Blood, slightly aged), EMPA117EH |
| | (Blood, Milk, Ink, extra heat-treated) from |
| | Center for Testmaterials B.V., Stoomloggerweg |
| | 11, 3133 KT Vlaardingen, The Netherlands. |
| | EMPA117EH from |
| Clean Ballast | WFK 10 A and WFK 80 A at a 50/50-ratio |
| textiles | (weight/weight). Up to 15 gr total weight |
| | together with the stains. (WFK-Testgewebe |
| | GmbH, Christenfeld 10, D-41379 Brueggen-Bracht, |
| | Germany) |

The following proteases were tested:
Metalloprotease having SEQ ID NO: 1
Serine protease having SEQ ID NO: 2
Protease having SEQ ID NO: 9
Serine protease having SEQ ID NO: 11
Serine protease having SEQ ID NO: 23
Serine protease having SEQ ID NO: 26

TABLE 2
Composition of detergents 1-1 to 1-4 and 2-1 to 2-4

| | Detergent formulation | | | | | | | | | | |
|---|---|---|---|---|---|---|---|---|---|---|---|
| | | 1-2/ | | | | | | | | | |
| | 1-1 | 2-2 | 1-3 | 1-4 | 2-1 | 2-3 | 2-4 | 3-1 | 3-2 | 3-3 | 3-4 |
| Ingredient | % Active matter | | | | | | | | | | |
| Na-LAS (Alkylbenzene- | 0.0 | 10.0 | 6.0 | 0.0 | 10.0 | 4.0 | 0.0 | 0.0 | 10.0 | 6.0 | 0.0 |
| sulfonic Acid) | | | | | | | | | | | |
| Rhamnolipid | 0.0 | 0.0 | 4.0 | 10.0 | 0.0 | 6.0 | 10.0 | 0.0 | 0.0 | 4.0 | 10.0 |
| MPG (1,2 Propanediol) | 2.0 | 2.0 | 2.0 | 2.0 | 2.0 | 2.0 | 2.0 | 2.0 | 2.0 | 2.0 | 2.0 |
| Boric acid | 0.8 | 0.8 | 0.8 | 0.8 | 0.8 | 0.8 | 0.8 | 0.0 | 0.0 | 0.0 | 0.0 |
| Sodium citrate (Trisodium | 0.0 | 0.0 | 0.0 | 0.0 | 6.0 | 2.0 | 6.0 | 0.0 | 0.0 | 0.0 | 0.0 |
| citrate, dihydrate) | | | | | | | | | | | |
| Phenoxyethanol | 1.0 | 1.0 | 1.0 | 1.0 | 1.0 | 1.0 | 1.0 | 1.0 | 1.0 | 1.0 | 1.0 |

| | |
|---|---|
| Citric acid | Adjust pH |
| NaOH | Adjust pH |
| Water | to 100% |

### Example 1: Evaluation of Wash Performance on C-S-01 (Blood, Aged) Swatches

Wash performance of Detergent 1-1 to 2-4 was tested using C-S-01 swatches by use of the Terg-o-tometer (TOM) Wash Assay as described above. The results clearly show that a detergent formulation with rhamnolipid but without LAS (i.e. Detergent 1-4 and Detergent 2-4) performs better than any of the detergents with LAS. The presence of protease increases the improved wash performance of the detergent formulation comprising rhamnolipid but without LAS.

TABLE EX1
Remission and Delta Remission (minus No Enzyme) on C-S-01 (Blood, aged) swatches
after TOM wash in detergents 1-1, 1-2, 1-3, 1-4, 2-1, 2-2, 2-3 and 2-4 in
the absence (No enzyme) or in the presence of 10 nM SEQ ID NO: 1, 10 nM SEQ
ID NO: 2 or 20 nM SEQ ID NO: 11, and subsequent rinse with tap water.

| Detergent | Detergent | Detergent | Detergent | Detergent | Detergent | Detergent | Detergent |
|---|---|---|---|---|---|---|---|
| 1-1 | 1-2 | 1-3 | 1-4 | 2-1 | 2-2 | 2-3 | 2-4 |

Average Remission 460 nm:

| | | | | | | | | |
|---|---|---|---|---|---|---|---|---|
| No Enzyme | 16.2 | 15.4 | 16.4 | 19.7 | 15.5 | 14.9 | 16.4 | 20.1 |
| 10 nM SEQ | 19.0 | 15.3 | 18.0 | 23.0 | 18.3 | 17.3 | 17.5 | 24.8 |
| ID NO: 1 | | | | | | | | |
| 10 nM SEQ | 15.3 | 16.0 | 17.5 | 20.8 | 15.9 | 16.3 | 16.9 | 23.9 |
| ID NO: 2 | | | | | | | | |
| 20 nM SEQ | 20.7 | 16.6 | 20.5 | 23.5 | 19.6 | 17.3 | 20.3 | 26.9 |
| ID NO: 11 | | | | | | | | |
| Unwashed | 13.0 | | | | | | | |

Delta Remission (minus no Enzyme)

| | | | | | | | | |
|---|---|---|---|---|---|---|---|---|
| 10 nM SEQ | 2.8 | −0.1 | 1.6 | 3.2 | 2.7 | 2.4 | 1.1 | 4.7 |
| ID NO: 1 | | | | | | | | |
| 10 nM SEQ | −0.9 | 0.6 | 1.1 | 1.0 | 0.4 | 1.4 | 0.6 | 3.8 |
| ID NO: 2 | | | | | | | | |
| 20 nM SEQ | 4.5 | 1.2 | 4.1 | 3.8 | 4.1 | 2.4 | 3.9 | 6.8 |
| ID NO: 11 | | | | | | | | |

### Example 2: Evaluation of Wash Performance on C-S-101 (Blood, Slightly Aged) Swatches

Wash performance of Detergent 1-1 to 2-4 was tested using C-S-101 swatches by use of the Terg-o-tometer (TOM) Wash Assay as described above. The results clearly show that a detergent formulation with rhamnolipid but without LAS b (i.e. Detergent 1-4 and Detergent 2-4) performs better than any of the detergents with LAS. The presence of protease increases the improved wash performance of the detergent formulation comprising rhamnolipid but without LAS.

TABLE EX2
Remission and Delta Remission (minus No Enzyme) on C-S-101 (Blood, slightly aged)
swatches after TOM wash in detergents 1-1, 1-2, 1-3, 1-4, 2-1, 2-2, 2-3 and 2-4
in the absence (No enzyme) or in the presence of 10 nM SEQ ID NO: 1, 10 nM SEQ
ID NO: 2 or 20 nM SEQ ID NO: 11, and subsequent rinse with tap water.

| Detergent | Detergent | Detergent | Detergent | Detergent | Detergent | Detergent | Detergent |
|---|---|---|---|---|---|---|---|
| 1-1 | 1-2 | 1-3 | 1-4 | 2-1 | 2-2 | 2-3 | 2-4 |

Average Remission 460 nm:

| | | | | | | | | |
|---|---|---|---|---|---|---|---|---|
| No Enzyme | 34.4 | 29.8 | 30.0 | 43.6 | 29.9 | 27.4 | 33.7 | 44.4 |
| 10 nM SEQ | 37.1 | 27.9 | 32.6 | 44.1 | 33.3 | 29.1 | 36.1 | 48.6 |
| ID NO: 1 | | | | | | | | |
| 10 nM SEQ | 36.6 | 27.7 | 32.3 | 44.5 | 34.4 | 27.0 | 35.9 | 48.3 |
| ID NO: 2 | | | | | | | | |
| 20 nM SEQ | 38.3 | 29.2 | 36.3 | 46.4 | 35.9 | 31.0 | 38.6 | 49.7 |
| ID NO: 11 | | | | | | | | |
| Unwashed | 12.2 | | | | | | | |

Delta Remissioin (minus no enzyme):

| | | | | | | | | |
|---|---|---|---|---|---|---|---|---|
| 10 nM SEQ | 2.7 | −1.9 | 2.6 | 0.5 | 3.4 | 1.7 | 2.4 | 4.2 |
| ID NO: 1 | | | | | | | | |
| 10 nM SEQ | 2.3 | −2.1 | 2.3 | 0.9 | 4.6 | −0.4 | 2.2 | 3.9 |
| ID NO: 2 | | | | | | | | |
| 20 nM SEQ | 3.9 | −0.6 | 6.3 | 2.8 | 6.1 | 3.6 | 4.8 | 5.3 |
| ID NO: 11 | | | | | | | | |

### Example 3: Evaluation of Wash Performance on C-S-07 (Grass, Pure) Swatches

Wash performance of Detergent 1-1 to 2-4 was tested using C-S-07 swatches by use of the Terg-o-tometer (TOM) Wash Assay as described above. The results clearly show that a detergent formulation with rhamnolipid but without LAS b (i.e. Detergent 1-4 and Detergent 2-4) performs better than any of the detergents with LAS. The presence of protease increases the improved wash performance of the detergent formulation comprising rhamnolipid but without LAS.

TABLE EX3
Remission and Delta Remission (minus No Enzyme) on C-S-07 (Grass, pure) swatches
after TOM wash in detergents 1-1, 1-2, 1-3, 1-4, 2-1, 2-2, 2-3 and 2-4 in
the absence (No enzyme) or in the presence of 10 nM SEQ ID NO: 1, 10 nM SEQ
ID NO: 2 or 20 nM SEQ ID NO: 11, and subsequent rinse with tap water.

| Detergent | Detergent | Detergent | Detergent | Detergent | Detergent | Detergent | Detergent |
|---|---|---|---|---|---|---|---|
| 1-1 | 1-2 | 1-3 | 1-4 | 2-1 | 2-2 | 2-3 | 2-4 |

Average Remission 460 nm:

| | | | | | | | | |
|---|---|---|---|---|---|---|---|---|
| No Enzyme | 28.6 | 28.0 | 28.8 | 30.9 | 28.2 | 27.5 | 31.3 | 31.6 |
| 10 nM SEQ | 29.6 | 29.2 | 30.1 | 30.5 | 28.2 | 28.7 | 32.3 | 32.8 |
| ID NO: 1 | | | | | | | | |
| 10 nM SEQ | 31.2 | 28.3 | 29.7 | 31.8 | 30.4 | 27.6 | 32.6 | 33.7 |
| ID NO: 2 | | | | | | | | |
| 20 nM SEQ | 29.7 | 28.9 | 31.8 | 35.2 | 29.6 | 28.6 | 34.7 | 36.1 |
| ID NO: 11 | | | | | | | | |
| Unwashed | 24.0 | | | | | | | |

Delta Remission (minus No Enzyme):

| | | | | | | | | |
|---|---|---|---|---|---|---|---|---|
| 10 nM SEQ | 1.0 | 1.2 | 1.2 | −0.4 | 0.0 | 1.2 | 1.1 | 1.2 |
| ID NO: 1 | | | | | | | | |
| 10 nM SEQ | 2.6 | 0.3 | 0.9 | 0.9 | 2.2 | 0.1 | 1.4 | 2.0 |
| ID NO: 2 | | | | | | | | |
| 20 nM SEQ | 1.0 | 0.9 | 2.9 | 4.4 | 1.4 | 1.1 | 3.5 | 4.5 |
| ID NO: 11 | | | | | | | | |

### Example 4: Evaluation of Wash Performance on PC-05 (Blood, Milk, Ink (BMI)) Swatches

Wash performance of Detergent 1-1 to 2-4 was tested using PC-05 swatches by use of the Terg-o-tometer (TOM) Wash Assay as described above. The results clearly show that a detergent formulation with rhamnolipid but without LAS b (i.e. Detergent 1-4 and Detergent 2-4) performs better than any of the detergents with LAS. The presence of protease increases the improved wash performance of the detergent formulation comprising rhamnolipid but without LAS.

TABLE EX4
Remission and Delta Remission (minus No Enzyme) on PC-05 (Blood, Milk, Ink (BMI))
swatches after TOM wash in detergemts 1-1, 1-2, 1-3, 1-4, 2-1, 2-2, 2-3 and 2-4
in the absence (No enzyme) or in the presence of 10 nM SEQ ID NO: 1, 10 nM SEQ
ID NO: 2 or 20 nM SEQ ID NO: 11, and subsequent rinse with tap water.

| Detergent | Detergent | Detergent | Detergent | Detergent | Detergent | Detergent | Detergent |
|---|---|---|---|---|---|---|---|
| 1-1 | 1-2 | 1-3 | 1-4 | 2-1 | 2-2 | 2-3 | 2-4 |

Average Remission 460 nm:

| | | | | | | | | |
|---|---|---|---|---|---|---|---|---|
| No Enzyme | 13.6 | 12.3 | 12.0 | 14.0 | 12.5 | 11.4 | 12.8 | 15.1 |
| 10 nM SEQ | 15.0 | 12.0 | 14.9 | 16.5 | 12.7 | 11.1 | 13.3 | 16.5 |
| ID NO: 1 | | | | | | | | |
| 10 nM SEQ | 14.6 | 12.1 | 12.8 | 15.0 | 12.7 | 11.8 | 13.3 | 14.8 |
| ID NO: 2 | | | | | | | | |
| 20 nM SEQ | 15.1 | 13.0 | 14.6 | 18.5 | 14.7 | 13.5 | 16.6 | 19.7 |
| ID NO: 11 | | | | | | | | |
| Unwashed | 11.2 | | | | | | | |

Delta Remission (minus No Enzyme):

| | | | | | | | | |
|---|---|---|---|---|---|---|---|---|
| 10 nM SEQ | 1.4 | −0.3 | 2.9 | 2.4 | 0.1 | −0.3 | 0.5 | 1.3 |
| ID NO: 1 | | | | | | | | |
| 10 nM SEQ | 1.0 | −0.2 | 0.8 | 0.9 | 0.1 | 0.4 | 0.5 | −0.3 |
| ID NO: 2 | | | | | | | | |
| 20 nM SEQ | 1.5 | 0.7 | 2.6 | 4.4 | 2.2 | 2.2 | 3.8 | 4.5 |
| ID NO: 11 | | | | | | | | |

### Example 5: Evaluation of Wash Performance on EMP117EH (Blood, Milk, Ink (BMI), Extra Heat-Treated)

Wash performance of Detergent 1-1 to 2-4 was tested using EMPH117EH swatches by use of the Terg-o-tometer (TOM) Wash Assay as described above. The results clearly show that a detergent formulation with rhamnolipid but without LAS b (i.e. Detergent 1-4 and Detergent 2-4) performs better than any of the detergents with LAS. The presence of protease increases the improved wash performance of the detergent formulation comprising rhamnolipid but without LAS.

TABLE EX5
Remission and Delta Remission (minus No Enzyme) on EMPA117EH (Blood, Milk, Ink (BMI),
extra heat-treated) swatches after TOM wash in detergents 1-1, 1-2, 1-3, 1-4, 2-1,
2-2, 2-3 and 2-4in the absence (No enzyme) or in the presence of 10 nM SEQ ID NO:
1, 10 nM SEQ ID NO: 2 or 20 nM SEQ ID NO: 11, and subsequent rinse with tap water.

| Detergent | Detergent | Detergent | Detergent | Detergent | Detergent | Detergent | Detergent |
|---|---|---|---|---|---|---|---|
| 1-1 | 1-2 | 1-3 | 1-4 | 2-1 | 2-2 | 2-3 | 2-4 |

Average Remission 460 nm:

| | | | | | | | | |
|---|---|---|---|---|---|---|---|---|
| No Enzyme | 14.5 | 12.7 | 13.2 | 14.8 | 13.2 | 13.1 | 13.3 | 15.1 |
| 10 nM SEQ | 15.7 | 13.7 | 13.6 | 16.4 | 13.7 | 13.2 | 14.1 | 19.5 |
| ID NO: 1 | | | | | | | | |
| 10 nM SEQ | 15.2 | 13.2 | 14.3 | 16.1 | 13.8 | 13.2 | 14.6 | 15.8 |
| ID NO: 2 | | | | | | | | |
| 20 nM SEQ | 21.5 | 14.0 | 15.7 | 24.3 | 16.4 | 14.1 | 16.9 | 27.3 |
| ID NO: 11 | | | | | | | | |
| Unwashed | 12.0 | | | | | | | |

Delta Remission (minus No Enzyme):

| | | | | | | | | |
|---|---|---|---|---|---|---|---|---|
| 10 nM SEQ | 1.2 | 1.0 | 0.4 | 1.6 | 0.5 | 0.2 | 0.8 | 4.4 |
| ID NO: 1 | | | | | | | | |
| 10 nM SEQ | 0.7 | 0.4 | 1.1 | 1.3 | 0.6 | 0.2 | 1.3 | 0.8 |
| ID NO: 2 | | | | | | | | |
| 20 nM SEQ | 7.0 | 1.3 | 2.5 | 9.5 | 3.1 | 1.0 | 3.6 | 12.2 |
| ID NO: 11 | | | | | | | | |

### Example 6: Evaluation of Wash Performance on EMP117EH (Blood, Milk, Ink (BMI), Extra Heat-Treated)

Wash performance of Detergent 1-1 to 1-4, and 3-1 to 3-4 was tested using EMPA117EH swatches by use of the Terg-o-tometer (TOM) Wash Assay as described above. The results clearly show that a detergent formulation with rhamnolipid but without LAS b (i.e. Detergent 1-4 and Detergent 3-4) performs better than any of the detergents with LAS. The presence of protease increases the improved wash performance of the detergent formulation comprising rhamnolipid but without LAS.

TABLE EX6
Remission and Delta Remission (minus No Enzyme) on EMPA117EH (Blood, Milk, Ink (BMI),
extra heat-treated) swatches after TOM wash in Formulations 1-1, 1-2, 1-3, 1-4, 3-1,
3-2, 3-3 and 3-4 in the absence (No enzyme) or in the presence of 20 nM SEQ ID NO:
9, 20 nM SEQ ID NO: 23 or 20 nM SEQ ID NO: 26, and subsequent rinse with tap water.

| Detergent | Detergent | Detergent | Detergent | Detergent | Detergent | Detergent | Detergent |
|---|---|---|---|---|---|---|---|
| 1-1 | 1-2 | 1-3 | 1-4 | 3-1 | 3-2 | 3-3 | 3-4 |

Average Remission 460 nm:

| | | | | | | | | |
|---|---|---|---|---|---|---|---|---|
| No Enzyme | 13.8 | 12.6 | 13.2 | 13.8 | 13.8 | 12.5 | 13.3 | 14.5 |
| 20 nM SEQ | 15.1 | 12.4 | 13.4 | 15.8 | 15.5 | 12.7 | 13.5 | 15.6 |
| ID NO: 23 | | | | | | | | |
| 20 nM SEQ | 18.0 | 13.5 | 14.6 | 20.5 | 17.7 | 12.9 | 14.5 | 20.7 |
| ID NO: 26 | | | | | | | | |
| 20 nM SEQ | 18.5 | 13.2 | 14.9 | 20.9 | 18.2 | 13.2 | 14.7 | 19.8 |
| ID NO: 9 | | | | | | | | |
| Unwashed | 14.0 | | | | | | | |

Delta Remission (minus No Enzyme):

| | | | | | | | | |
|---|---|---|---|---|---|---|---|---|
| 20 nM SEQ | 1.3 | −0.2 | 0.2 | 2.0 | 1.7 | 0.2 | 0.2 | 1.1 |
| ID NO: 23 | | | | | | | | |
| 20 nM SEQ | 4.2 | 0.9 | 1.5 | 6.7 | 3.9 | 0.4 | 1.2 | 6.2 |
| ID NO: 26 | | | | | | | | |
| 20 nM SEQ | 4.7 | 0.6 | 1.7 | 7.2 | 4.4 | 0.7 | 1.4 | 5.3 |
| ID NO: 9 | | | | | | | | |

### Example 7: Evaluation of Wash Performance on C-S-01 (Blood, Aged)

Wash performance of Detergent 1-1 to 1-4, and 3-1 to 3-4 was tested using C-S-01 swatches by use of the Terg-o-tometer (TOM) Wash Assay as described above. The results clearly show that a detergent formulation with rhamnolipid but without LAS b (i.e. Detergent 1-4 and Detergent 3-4) performs better than any of the detergents with LAS. The presence of protease increases the improved wash performance of the detergent formulation comprising rhamnolipid but without LAS.

TABLE EX7
Remission and Delta Remission (minus No Enzyme) on C-S-01 (Blood, aged) swatches
after TOM wash in Formulations 1-1, 1-2, 1-3, 1-4, 3-1, 3-2, 3-3 and 3-4 in
the absence (No enzyme) or in the presence of 20 nM 20 nM SEQ ID NO: 9, 20
nM SEQ ID NO: 23 or 20 nM SEQ ID NO: 26, and subsequent rinse with tap water.

| Detergent | Detergent | Detergent | Detergent | Detergent | Detergent | Detergent | Detergent |
|---|---|---|---|---|---|---|---|
| 1-1 | 1-2 | 1-3 | 1-4 | 3-1 | 3-2 | 3-3 | 3-4 |

Average Remission 460 nm:

| | | | | | | | | |
|---|---|---|---|---|---|---|---|---|
| No Enzyme | 17.7 | 14.3 | 17.5 | 21.0 | 17.9 | 15.4 | 15.9 | 19.9 |
| 20 nM SEQ | 19.4 | 17.5 | 19.0 | 21.0 | 18.5 | 18.1 | 16.6 | 20.0 |
| ID NO: 23 | | | | | | | | |
| 20 nM SEQ | 20.3 | 17.6 | 21.4 | 25.8 | 21.8 | 18.1 | 19.0 | 22.3 |
| ID NO: 26 | | | | | | | | |
| 20 nM SEQ | 22.2 | 18.6 | 20.0 | 25.8 | 23.5 | 16.7 | 18.2 | 24.4 |
| ID NO: 9 | | | | | | | | |
| Unwashed | 13 ,. 4 | | | | | | | |

Delta Remission (minus No Enzyme):

| | | | | | | | | |
|---|---|---|---|---|---|---|---|---|
| 20 nM SEQ | 1.7 | 3.2 | 1.4 | 0.0 | 0.6 | 2.6 | 0.7 | 0.1 |
| ID NO: 23 | | | | | | | | |
| 20 nM SEQ | 2.6 | 3.3 | 3.8 | 4.9 | 4.0 | 2.7 | 3.1 | 2.4 |
| ID NO: 26 | | | | | | | | |
| 20 nM SEQ | 4.6 | 4.3 | 2.5 | 4.9 | 5.6 | 1.2 | 2.3 | 4.5 |
| ID NO: 9 | | | | | | | | |

### Example 8: Evaluation of Wash Performance on C-S-101 (Blood, Slightly Aged)

Wash performance of Detergent 1-1 to 1-4, and 3-1 to 3-4 was tested using C-S-101 swatches by use of the Terg-o-tometer (TOM) Wash Assay as described above. The results clearly show that a detergent formulation with rhamnolipid but without LAS b (i.e. Detergent 1-4 and Detergent 3-4) performs better than any of the detergents with LAS. The presence of protease increases the improved wash performance of the detergent formulation comprising rhamnolipid but without LAS.

TABLE EX8
Remission and Delta Remission (minus No Enzyme) on C-S-101 (Blood, slightly aged)
swatches after TOM wash in Formulations 1-1, 1-2, 1-3, 1-4, 3-1, 3-2, 3-3 and
3-4 in the absence (No enzyme) or in the presence of 20 nM SEQ ID NO: 9, 20
nM SEQ ID NO: 23 or 20 nM SEQ ID NO: 26, and subsequent rinse with tap water.

| Detergent | Detergent | Detergent | Detergent | Detergent | Detergent | Detergent | Detergent |
|---|---|---|---|---|---|---|---|
| 1-1 | 1-2 | 1-3 | 1-4 | 3-1 | 3-2 | 3-3 | 3-4 |

Average Remission 460 nm:

| | | | | | | | | |
|---|---|---|---|---|---|---|---|---|
| No Enzyme | 35.3 | 26.9 | 31.9 | 44.2 | 40.7 | 37.4 | 30.5 | 43.9 |
| 20 nM SEQ | 35.6 | 28.2 | 34.5 | 44.1 | 38.3 | 31.7 | 32.3 | 45.0 |
| ID NO: 23 | | | | | | | | |
| 20 nM SEQ | 37.7 | 30.2 | 38.7 | 52.3 | 40.8 | 29.8 | 33.1 | 52.6 |
| ID NO: 26 | | | | | | | | |
| 20 nM SEQ | 37.7 | 31.8 | 37.8 | 49.6 | 38.9 | 28.6 | 34.1 | 48.9 |
| ID NO: 9 | | | | | | | | |
| Unwashed | 12.0 | | | | | | | |

Delta Remission (minus No Enzyme):

| | | | | | | | | |
|---|---|---|---|---|---|---|---|---|
| 20 nM SEQ | 0.3 | 1.4 | 2.7 | −0.1 | −2.4 | −5.7 | 1.8 | 1.0 |
| ID NO: 23 | | | | | | | | |
| 20 nM SEQ | 2.5 | 3.3 | 6.9 | 8.0 | 0.1 | −7.6 | 2.6 | 8.6 |
| ID NO: 26 | | | | | | | | |
| 20 nM SEQ | 2.4 | 4.9 | 6.0 | 5.3 | −1.8 | −8.8 | 3.6 | 5.0 |
| ID NO: 9 | | | | | | | | |

### Example 9: Evaluation of Wash Performance on C-S-07 (Grass, Pure)

Wash performance of Detergent 1-1 to 1-4, and 3-1 to 3-4 was tested using C-S-07 swatches by use of the Terg-o-tometer (TOM) Wash Assay as described above. The results clearly show that a detergent formulation with rhamnolipid but without LAS b (i.e. Detergent 1-4 and Detergent 3-4) performs better than any of the detergents with LAS. The presence of protease increases the improved wash performance of the detergent formulation comprising rhamnolipid but without LAS.

TABLE EX9
Remission and Delta Remission (minus No Enzyme) on C-S-07 (Grass, pure) swatches
after TOM wash in Formulations 1-1, 1-2, 1-3, 1-4, 3-1, 3-2, 3-3 and 3-4 in
the absence (No enzyme) or in the presence of 20 nM SEQ ID NO: 9, 20 nM SEQ
ID NO: 23 or 20 nM SEQ ID NO: 26, and subsequent rinse with tap water.

| Detergent | Detergent | Detergent | Detergent | Detergent | Detergent | Detergent | Detergent |
|---|---|---|---|---|---|---|---|
| 1-1 | 1-2 | 1-3 | 1-4 | 3-1 | 3-2 | 3-3 | 3-4 |

Average Remission 460 nm:

| | | | | | | | | |
|---|---|---|---|---|---|---|---|---|
| No Enzyme | 30.5 | 27.4 | 29.7 | 32.0 | 29.0 | 28.8 | 29.4 | 31.0 |
| 20 nM SEQ | 30.6 | 29.2 | 29.7 | 33.7 | 31.2 | 28.3 | 30.0 | 32.2 |
| ID NO: 23 | | | | | | | | |
| 20 nM SEQ | 31.1 | 29.5 | 31.0 | 34.2 | 29.4 | 29.4 | 29.7 | 33.4 |
| ID NO: 26 | | | | | | | | |
| 20 nM SEQ | 30.7 | 30.8 | 32.9 | 33.6 | 32.0 | 31.0 | 32.4 | 33.9 |
| ID NO: 9 | | | | | | | | |
| Unwashed | 21.3 | | | | | | | |

Delta Remission (minus No Enzyme):

| | | | | | | | | |
|---|---|---|---|---|---|---|---|---|
| 20 nM SEQ | 0.1 | 1.8 | 0.0 | 1.7 | 2.1 | −0.5 | 0.6 | 1.2 |
| ID NO: 23 | | | | | | | | |
| 20 nM SEQ | 0.6 | 2.0 | 1.3 | 2.3 | 0.4 | 0.6 | 0.4 | 2.4 |
| ID NO: 26 | | | | | | | | |
| 20 nM SEQ | 0.1 | 3.3 | 3.2 | 1.6 | 3.0 | 2.2 | 3.0 | 3.0 |
| ID NO: 9 | | | | | | | | |

### Example 10: Evaluation of Wash Performance on PC-05 (Blood, Milk, Ink (BMI))

Wash performance of Detergent 1-1 to 1-4, and 3-1 to 3-4 was tested using PC-05 swatches by use of the Terg-o-tometer (TOM) Wash Assay as described above. The results clearly show that a detergent formulation with rhamnolipid but without LAS b (i.e. Detergent 1-4 and Detergent 3-4) performs better than any of the detergents with LAS. The presence of protease increases the improved wash performance of the detergent formulation comprising rhamnolipid but without LAS.

TABLE EX 10
Remission and Delta Remission (minus No Enzyme) on PC-05 (Blood, Milk, Ink (BMI))
swatches after TOM wash in Formulations 1-1, 1-2, 1-3, 1-4, 3-1, 3-2, 3-3 and
3-4 in the absence (No enzyme) or in the presence of 20 nM SEQ ID NO: 9, 20
nM SEQ ID NO: 23 or 20 nM SEQ ID NO: 26, and subsequent rinse with tap water.

| Detergent | Detergent | Detergent | Detergent | Detergent | Detergent | Detergent | Detergent |
|---|---|---|---|---|---|---|---|
| 1-1 | 1-2 | 1-3 | 1-4 | 3-1 | 3-2 | 3-3 | 3-4 |

Average Remission 460 nM

| | | | | | | | | |
|---|---|---|---|---|---|---|---|---|
| No Enzyme | 13.8 | 12.7 | 12.6 | 16.3 | 14.2 | 12.1 | 13.5 | 14.4 |
| 20 nM SEQ | 15.0 | 12.3 | 13.0 | 16.5 | 14.9 | 13.3 | 13.9 | 16.6 |
| ID NO: 23 | | | | | | | | |
| 20 nM SEQ | 15.6 | 13.2 | 13.4 | 19.2 | 15.7 | 12.6 | 14.8 | 18.3 |
| ID NO: 26 | | | | | | | | |
| 20 nM SEQ | 17.7 | 13.0 | 15.2 | 18.6 | 17.0 | 12.9 | 14.0 | 19.1 |
| ID NO: 9 | | | | | | | | |
| Unwashed | 12.6 | | | | | | | |

Delta Remission (minus No Enzyme)

| | | | | | | | | |
|---|---|---|---|---|---|---|---|---|
| 20 nM SEQ | 1.3 | −0.4 | 0.4 | 0.2 | 0.7 | 1.1 | 0.4 | 2.2 |
| ID NO: 23 | | | | | | | | |
| 20 nM SEQ | 1.8 | 0.5 | 0.8 | 3.0 | 1.5 | 0.4 | 1.3 | 3.9 |
| ID NO: 26 | | | | | | | | |
| 20 nM SEQ | 3.9 | 0.3 | 2.6 | 2.3 | 2.8 | 0.8 | 0.5 | 4.7 |
| ID NO: 9 | | | | | | | | |

1. A detergent composition having improved sustainability profile, wherein the sustainability profile of the detergent composition is improved by replacing alkylbenzene sulfonate fully or substantially with a surfactant that can be obtained by fermentation (biosurfactant), wherein the wash performance of the composition is maintained at at least the same level as when alkylbenzene sulfonate is present.

2. The detergent composition according to claim 1, wherein the biosurfactant is selected from the group consisting of rhamnolipid, sophorolipid and mannosylerythritol lipids.

3. The detergent composition according to claim 1 further comprising a protease.

4. The detergent composition according to claim 3, wherein the protease is selected from the group consisting of metalloproteases, serine protease, aspartic protease, cysteine protease, amino peptidase and carboxy peptidase.

5. The detergent composition according to claim 4, wherein the protease is a metallo protease or a serine protease.

6. The detergent composition according to claim 3, wherein the protease has an amino acid sequence having at least 60%, at least 65%, at least 70%, at least 75%, at least 80%, at least 85%, at least 90%, at least 95%, at least 96%, at least 97%, at least 98%, at least 99% or even 100% sequence identity to any of the sequences selected from the group consisting of SEQ ID NO: 11, SEQ ID NO: 1, SEQ ID NO: 2, SEQ ID NO: 3, SEQ ID NO: 4, SEQ ID NO: 5, SEQ ID NO: 6, SEQ ID NO: 7, SEQ ID NO: 8, SEQ ID NO: 9, SEQ ID NO: 10, SEQ ID NO: 12, SEQ ID NO: 13, SEQ ID NO: 14, SEQ ID NO: 15, SEQ ID NO: 16, SEQ ID NO: 17, SEQ ID NO: 18, SEQ ID NO: 19, SEQ ID NO: 20, SEQ ID NO: 21, SEQ ID NO: 22, SEQ ID NO: 23, SEQ ID NO: 24 and SEQ ID NO: 25.

7. The detergent composition according to claim 3 comprising a protease and at least one additional enzyme, wherein the at least one additional enzyme is selected from the group consisting of cellulase, amylase, deoxyribonuclease, lipase, xyloglucanase, cutinase, pectinase, xanthanase, peroxidase, haloperoxygenase, catalase and mannanase.

8. The detergent composition according to claim 7, wherein the protease and/or the at least one additional enzyme is present in the detergent composition in an amount corresponding to from 0.0001% to 5% (w/w) active enzyme protein.

9. (canceled)

10. (canceled)

11. The detergent composition according to claim 1, wherein the detergent composition comprises 1-20% (w/w) rhamnolipid.

12. The detergent composition according to claim 1, wherein the detergent composition comprises 1-20% (w/w) lauryl ethersulfate, such as sodium lauryl ether sulfate.

13. A method of cleaning a surface, the method comprising application of a detergent composition according to claim 1 to a surface to be cleaned.

14. The method of claim 13, wherein the method of cleaning is selected from hand dish washing, automated dish washing, hard surface cleaning and laundering.

15. The method of claim 14, wherein the method of cleaning is laundering and the wash performance in the laundry wash, as measured by REM or delta REM of an item is at least maintained, optionally improved when LAS is replaced with biosurfactant after at least one wash cycle.
